(19) United States
(12) Patent Application Publication
(10) Pub. No.: US 2024/0430429 A1
(43) Pub. Date: Dec. 26, 2024

(54) IMAGE PROCESSING SYSTEM, IMAGE PROCESSING DEVICE, IMAGE PROCESSING METHOD, AND COMPUTER-READABLE RECORDING MEDIUM STORING IMAGE PROCESSING PROGRAM

(71) Applicant: Fujitsu Limited, Kawasaki-shi (JP)

(72) Inventors: Tomonori KUBOTA, Kawasaki (JP); Akihiro YAMORI, Kawasaki (JP); Yasuyuki MURATA, Shizuoka (JP)

(73) Assignee: Fujitsu Limited, Kawasaki-shi (JP)

(21) Appl. No.: 18/824,550

(22) Filed: Sep. 4, 2024

Related U.S. Application Data
(63) Continuation of application No. PCT/JP2022/014239, filed on Mar. 25, 2022.

(51) Int. Cl. H04N 19/124; H04N 19/146; H04N 19/154; H04N 19/167; H04N 19/176; H04N 19/30; H04N 19/40; H04N 19/593

(52) U.S. Cl. CPC H04N 19/124; H04N 19/146; H04N 19/154; H04N 19/167; H04N 19/176; H04N 19/30; H04N 19/40; H04N 19/593

(57) ABSTRACT

An image processing system includes a hierarchical encoder that determines, based on recognition processing, a target area needed to recognize a recognition target and a non-target area other than the target area in image data, a quantization value of the target area needed to recognize the recognition target, and a quantization value of the non-target area, encodes an entire area of the image data with the quantization value of the target area to generate first encoded data, and encodes the entire area of the image data with the quantization value of the non-target area to generate second encoded data, and a transcoder that generates reconstructed image data by using the target area in first decoded data obtained by decoding the first encoded data and the non-target area in second decoded data obtained by decoding the second encoded data, and re-encodes the reconstructed image data to generate re-encoded data.

### CROSS-REFERENCE TO RELATED APPLICATION

This application is a continuation application of International Application PCT/JP2022/014239 filed on Mar. 25, 2022, and designated the U.S., the entire contents of which are incorporated herein by reference.

### FIELD

The embodiments discussed herein are related to an image processing system, an image processing device, an image processing method, and an image processing program.

### BACKGROUND

Commonly, when image data is recorded or transmitted, a data size is reduced by encoding to reduce recording cost and transmission cost.

Meanwhile, when image data is recorded or transmitted for the purpose of being used for recognition processing by artificial intelligence (AI), a method is conceivable in which a quantization value (which is a parameter for determining a compression rate, includes a quantization parameter, a quantization step size, etc., and corresponds to, for example, a quantization parameter (QP) value of the moving image encoding standard H.265/HEVC) of each area is increased to a limit that allows the AI to recognize a recognition target (e.g., limit quantization value is used) to carry out encoding.

Here, the encoding method as described above may not be applied in a case of an imaging device having a specification constraint, such as a desired different quantization value may not be set for each area in a captured image (e.g., same quantization value is set for all areas).

Meanwhile, for example, when processing such as black-painting is performed on an area other than a target area needed to recognize the recognition target and then all the areas are encoded with the limit quantization value, the data size of the encoded data may be reduced even in the case of the imaging device as described above.

Japanese Laid-open Patent Publication No. 2021-118522, Japanese Laid-open Patent Publication No. 2012-129608, and Japanese Laid-open Patent Publication No. 2000-13792 are disclosed as related art.

### SUMMARY

According to an aspect of the embodiments, an image processing system includes a hierarchical encoder that determines, based on a result of recognition processing, a target area needed to recognize a recognition target and a non-target area other than the target area in image data, a quantization value of the target area needed to recognize the recognition target, and a quantization value of the non-target area, encodes an entire area of the image data with the quantization value of the target area to generate first encoded data, and encodes the entire area of the image data with the quantization value of the non-target area to generate second encoded data, and a transcoder that generates reconstructed image data by using the target area in first decoded data obtained by decoding the first encoded data and the non-target area in second decoded data obtained by decoding the second encoded data, and re-encodes the reconstructed image data to generate re-encoded data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a first diagram illustrating an exemplary system configuration of an image processing system;

FIG. 1B is a second diagram illustrating an exemplary system configuration of the image processing system;

FIG. 1C is a third diagram illustrating an exemplary system configuration of the image processing system;

FIGS. 2A and 2B are diagrams illustrating exemplary hardware configurations of an image processing device and a server device;

FIG. 3 is a first diagram illustrating an exemplary functional configuration of a hierarchical encoding device;

FIG. 4 is a first diagram illustrating an exemplary functional configuration of a transcode unit;

FIG. 5 is a first diagram illustrating a specific example of processing of the hierarchical encoding device and the transcode unit;

FIG. 6 is a first flowchart illustrating a flow of image processing;

FIG. 7 is a second diagram illustrating an exemplary functional configuration of the transcode unit;

FIG. 8 is a second diagram illustrating a specific example of the processing of the hierarchical encoding device and the transcode unit;

FIG. 9 is a second flowchart illustrating the flow of the image processing;

FIG. 10A is a second diagram illustrating an exemplary functional configuration of the hierarchical encoding device;

FIG. 10B is a third diagram illustrating an exemplary functional configuration of the transcode unit;

FIG. 11 is a third flowchart illustrating the flow of the image processing;

FIG. 12 is a fourth diagram illustrating an exemplary functional configuration of the transcode unit;

FIG. 13 is a fourth flowchart illustrating the flow of the image processing;

FIG. 14 is a fifth diagram illustrating an exemplary functional configuration of the transcode unit;

FIG. 15 is a first diagram illustrating a specific example of processing of a correction coefficient calculation unit;

FIGS. 16A and 16B are fifth flowcharts illustrating the flow of the image processing;

FIG. 17A is a third diagram illustrating an exemplary functional configuration of the hierarchical encoding device;

FIG. 17B is a sixth diagram illustrating an exemplary functional configuration of the transcode unit;

FIG. 18 is a first diagram illustrating a specific example of processing of a quantization value calculation unit;

FIG. 19 is a sixth flowchart illustrating the flow of the image processing;

FIG. 20 is a diagram illustrating a specific example of processing of the quantization value calculation unit and a quantization value map generation unit;

FIGS. 21A and 21B are seventh flowcharts illustrating the flow of the image processing;

FIG. 22 is a seventh diagram illustrating an exemplary functional configuration of the transcode unit;

FIG. 23 is a second diagram illustrating a specific example of the processing of the quantization value calculation unit;

FIGS. 24A and 24B are eighth flowcharts illustrating the flow of the image processing;

FIG. 25 is an eighth diagram illustrating an exemplary functional configuration of the transcode unit;

FIG. 26 is a ninth flowchart illustrating the flow of the image processing;

FIG. 27 is a ninth diagram illustrating an exemplary functional configuration of the transcode unit;

FIG. 28 is a second diagram illustrating a specific example of the processing of the correction coefficient calculation unit;

FIGS. 29A and 29B are tenth flowcharts illustrating the flow of the image processing;

FIG. 30 is a tenth diagram illustrating an exemplary functional configuration of the transcode unit;

FIG. 31 is a third diagram illustrating a specific example of the processing of the correction coefficient calculation unit;

FIGS. 32A and 32B are 11th flowcharts illustrating the flow of the image processing;

FIG. 33 is an 11th diagram illustrating an exemplary functional configuration of the transcode unit;

FIG. 34 is a fourth diagram illustrating a specific example of the processing of the correction coefficient calculation unit;

FIGS. 35A and 35B is 12th flowcharts illustrating the flow of the image processing;

FIG. 36 is a 12th diagram illustrating an exemplary functional configuration of the transcode unit;

FIG. 37 is a fifth diagram illustrating a specific example of the processing of the correction coefficient calculation unit; and

FIGS. 38A and 38B are 13th flowcharts illustrating the flow of the image processing.

### DESCRIPTION OF EMBODIMENTS

When the processing such as black-painting is performed on an area other than the target area, it becomes difficult to use the area other than the target area in decoded data as image data. In view of the above, in order to make it possible to use the area other than the target area, for example, a method is conceivable in which the processing such as black-painting is performed on the target area, and then all the areas are encoded with a predetermined quantization value to separately perform transmission as encoded data. According to such a method, when a reception device reconstructs two types of decoded data, the AI is enabled to recognize the recognition target, and image data may be generated such that the area other than the target area is usable.

However, according to such a method, two types of encoded data are transmitted with respect to one image, and a function of receiving and decoding the two types of encoded data and a function of reconstruction need to be incorporated in the reception device.

In one aspect, an object is to provide an image processing system, an image processing device, an image processing method, and an image processing program suitable for transmitting an image used for recognition processing by AI.

Hereinafter, each embodiment will be described with reference to the accompanying drawings. Note that, in the present specification and the drawings, components having substantially the same functional configuration are denoted by the same reference signs, and redundant description will be omitted.

### First Embodiment

### <System Configuration of Image Processing System>

First, a system configuration of an image processing system that encodes and transmits moving image data, performs recognition processing on decoded data using AI at a transmission destination, records encoded data, and displays the decoded data to a user as needed will be described.

### (1) First System Configuration

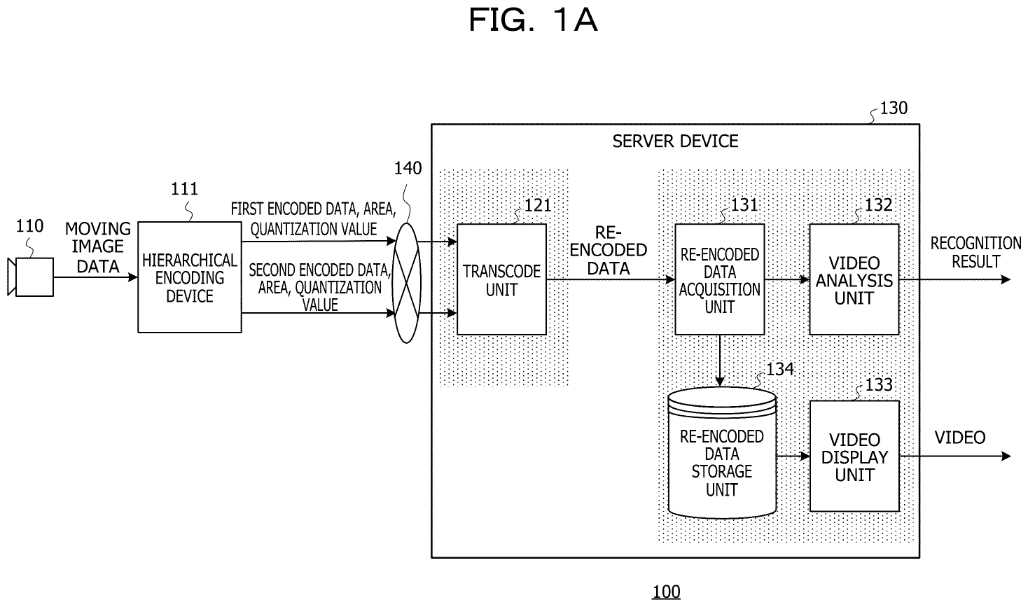

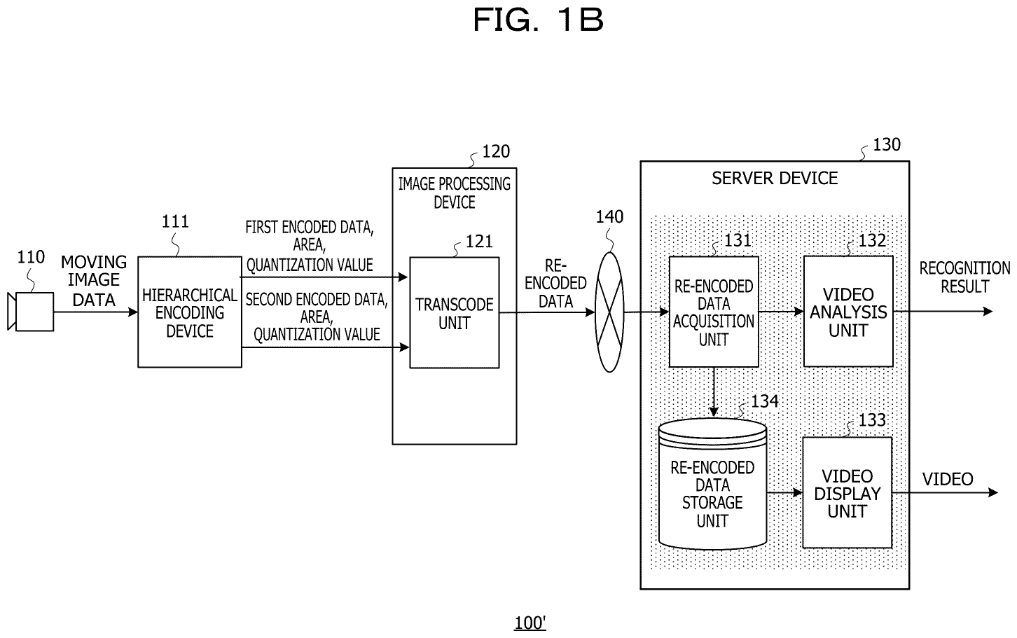

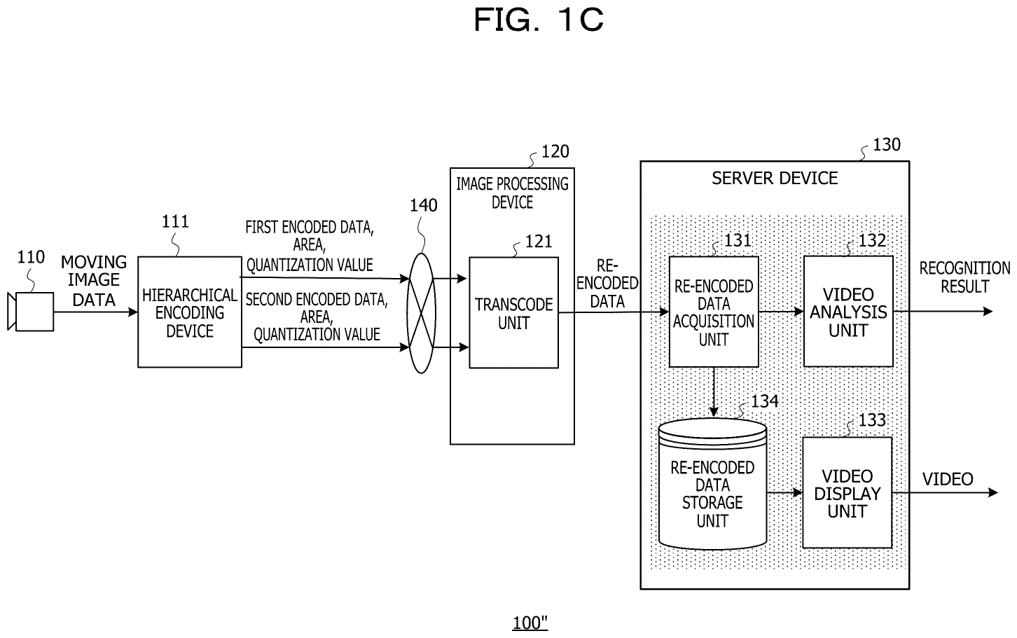

FIG. 1A is a first diagram illustrating an exemplary system configuration of the image processing system. As illustrated in FIG. 1A, the image processing system 100 includes an imaging device 110, a hierarchical encoding device 111, and a server device 130. The hierarchical encoding device 111 and the server device 130 are communicably coupled to each other via a network 140.

The imaging device 110 performs imaging in a predetermined frame cycle, and transmits moving image data to the hierarchical encoding device 111.

The hierarchical encoding device 111 is disposed in the vicinity of the imaging device 110. The hierarchical encoding device 111 encodes image data of each frame included in the moving image data, and generates first encoded data. At the time of generating the first encoded data, the hierarchical encoding device 111 makes a determination regarding:
an area (target area) needed for the AI to recognize a recognition target included in the image data; and
a quantization value (limit quantization value) of a limit needed for the AI to recognize the recognition target included in the image data,
to encode all areas of the image data with the same limit quantization value.

Furthermore, the hierarchical encoding device 111 encodes image data of each frame included in the moving image data, and generates second encoded data. At the time of generating the second encoded data, the hierarchical encoding device 111 makes a determination regarding:
an area (non-target area) other than the area needed for the AI to recognize the recognition target included in the image data; and
a predetermined quantization value suitable for encoding the non-target area,
to encode all the areas of the image data with the same predetermined quantization value.

Moreover, the hierarchical encoding device 111 transmits, to the server device 130, the following items:
the first encoded data and information regarding the area and the quantization value determined at the time of generating the first encoded data; and
the second encoded data and information regarding the area and the quantization value determined at the time of generating the second encoded data.

An image processing program is installed in the server device 130, and execution of the program causes the server device 130 to function as a transcode unit 121. Furthermore, an image recognition program is installed in the server device 130, and execution of the program causes the server device 130 to function as a re-encoded data acquisition unit 131, a video analysis unit 132, and a video display unit 133.

The transcode unit 121 decodes the first encoded data and the second encoded data transmitted from the hierarchical encoding device 111, and generates first decoded data and second decoded data. Furthermore, based on the information regarding the area transmitted from the hierarchical encoding device 111, the transcode unit 121 extracts the target area from the first decoded data, and extracts the non-target area from the second decoded data. Furthermore, the transcode unit 121 combines the extracted target area and the non-target area to generate reconstructed image data.

Furthermore, the transcode unit 121 generates re-encoded data by:
encoding the target area in the reconstructed image data with the limit quantization value or a quantization value close to the limit quantization value; and
encoding the non-target area in the reconstructed image data with a predetermined quantization value,
based on the information regarding the area and the quantization value transmitted from the hierarchical encoding device 111. Moreover, the transcode unit 121 notifies the re-encoded data acquisition unit 131 of the re-encoded data.

The re-encoded data acquisition unit 131 obtains the re-encoded data to notify the video analysis unit 132 of the re-encoded data, and also stores the re-encoded data in a re-encoded data storage unit 134.

The video analysis unit 132 decodes the re-encoded data notified from the re-encoded data acquisition unit 131, and generates decoded data. Furthermore, the video analysis unit 132 performs recognition processing by the AI on the generated decoded data, and recognizes the recognition target included in the decoded data. Moreover, the video analysis unit 132 outputs a recognition result to the user.

Furthermore, the video display unit 133 reads and decodes the re-encoded data in a range designated by the user from the re-encoded data stored in the re-encoded data storage unit 134, and generates decoded data. Furthermore, the video display unit 133 displays the generated decoded data as video data to the user.

As described above, when the hierarchical encoding device 111 disposed in the vicinity of the imaging device 110 is not enabled to set a different quantization value for each area with respect to the captured image data, the image processing system 100 performs processing of:
newly arranging the transcode unit 121; and
integrating the first encoded data and the second encoded data
transmitted from the hierarchical encoding device 111 to generate re-encoded data, and notifying the re-encoded data acquisition unit 131 of the re-encoded data.

As a result, according to the image processing system 100,
The first encoded data and the second encoded data are not directly input to the re-encoded data acquisition unit 131, whereby a function of receiving two types of encoded data and a function of reconstruction do not need to be incorporated into the image recognition program;
The first encoded data and the second encoded data are transmitted, whereby reduction in the transmission data volume between the hierarchical encoding device 111 and the server device 130 may be maintained;
The re-encoded data having the data volume nearly equal to that of the first encoded data and the second encoded data is stored, whereby the stored data volume stored in the server device 130 may be reduced;
The target area needed for the AI for recognition and the limit quantization value needed for the AI for recognition are secured, whereby the video analysis unit 132 may implement the recognition processing by the AI with high recognition accuracy; and
When the re-encoded data stored in the re-encoded data storage unit 134 is read and decoded, the non-target area that is an area other than the target area in the decoded data may be used as image data.

As described above, according to the first embodiment, the image processing system 100, the image processing method, and the image processing program suitable for transmitting images used for the recognition processing by the AI may be provided.

### (2) Second System Configuration

FIGS. 1B and 1C are second and third diagrams illustrating exemplary system configurations of the image processing system. As illustrated in FIGS. 1B and 1C, an image processing system 100′ or 100″ includes the imaging device 110, the hierarchical encoding device 111, an image processing device 120, and the server device 130. The image processing device 120 and the server device 130 (or the hierarchical encoding device 111 and the image processing device 120) are communicably coupled to each other via the network 140.

Among them, the imaging device 110 and the hierarchical encoding device 111 are the same as the imaging device 110 and the hierarchical encoding device 111 illustrated in FIG. 1A, and thus descriptions thereof will be omitted here. Note that the hierarchical encoding device 111 transmits, to the image processing device 120, the following items:
the first encoded data and the information regarding the area and the quantization value determined at the time of generating the first encoded data; and
the second encoded data and the information regarding the area and the quantization value determined at the time of generating the second encoded data.

The image processing program is installed in the image processing device 120, and execution of the program causes the image processing device 120 to function as the transcode unit 121.

The transcode unit 121 decodes the first encoded data and the second encoded data transmitted from the hierarchical encoding device 111, and generates first decoded data and second decoded data. Furthermore, based on the information regarding the area transmitted from the hierarchical encoding device 111, the transcode unit 121 extracts the target area from the first decoded data, and extracts the non-target area from the second decoded data. Furthermore, the transcode unit 121 combines the extracted target area and the non-target area to generate reconstructed image data.

Furthermore, the transcode unit 121 generates re-encoded data by:
encoding the target area with the limit quantization value or a quantization value close to the limit quantization value; and
encoding the non-target area with a predetermined quantization value,
with respect to the reconstructed image data generated based on the information regarding the area and the quantization value transmitted from the hierarchical encoding device 111. Moreover, the transcode unit 121 transmits the re-encoded data to the server device 130.

The image recognition program is installed in the server device 130, and execution of the image recognition program causes the server device 130 to function as the re-encoded data acquisition unit 131, the video analysis unit 132, and the video display unit 133.

Note that the re-encoded data acquisition unit 131, the video analysis unit 132, and the video display unit 133 illustrated in FIGS. 1B and 1C are the same as the re-encoded data acquisition unit 131, the video analysis unit 132, and the video display unit 133 illustrated in FIG. 1A, and thus descriptions thereof will be omitted here.

As described above, when the hierarchical encoding device 111 disposed in the vicinity of the imaging device 110 is not enabled to set a different quantization value for each area with respect to the captured image data, the image processing system 100′ or 100″ performs processing of:
newly arranging the image processing device 120 to cause it to function as the transcode unit 121; and
integrating the first encoded data and the second encoded data notified from the hierarchical encoding device 111 to generate re-encoded data, and transmitting the re-encoded data to the server device 130.

As a result, according to the image processing system 100′ or 100″,
The first encoded data and the second encoded data are not directly input to the server device 130, whereby a function of receiving two types of encoded data and a function of reconstruction do not need to be incorporated into the image recognition program of the server device 130;
The re-encoded data having the data volume nearly equal to that of the first encoded data and the second encoded data is transmitted, whereby reduction in the transmission data volume between the image processing device 120 and the server device 130 (or between the hierarchical encoding device 111 and the image processing device 120) may be maintained;
The re-encoded data having the data volume nearly equal to that of the first encoded data and the second encoded data is stored, whereby the stored data volume stored in the server device 130 may be reduced;
The target area needed for the AI for recognition and the limit quantization value needed for the AI for recognition are secured, whereby the video analysis unit 132 may implement the recognition processing by the AI with high recognition accuracy; and
When the re-encoded data stored in the re-encoded data storage unit 134 is read and decoded, the non-target area that is an area other than the target area in the decoded data may be used as image data.

As described above, according to the first embodiment, the image processing device 120, the image processing system 100′ or 100″, the image processing method, and the image processing program suitable for transmitting images used for the recognition processing by the AI may be provided.

### <Hardware Configurations of Image Processing Device and Server Device>

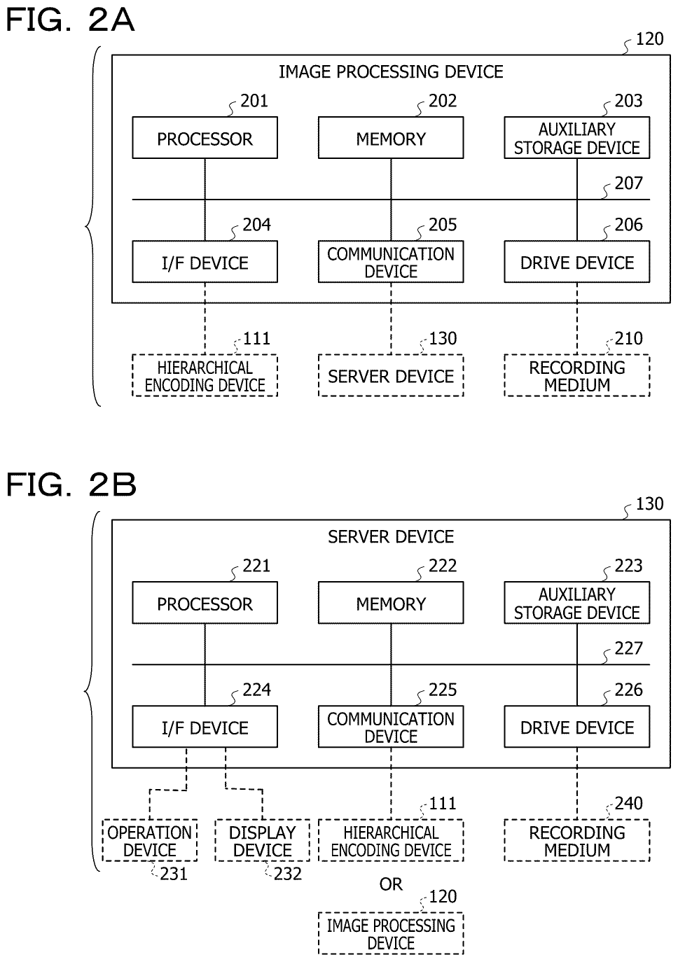

Next, a hardware configuration of the image processing device 120 of the image processing system 100′ or 100″, and a hardware configuration of the server device 130 of the image processing system 100 or the server device 130 of the image processing system 100′ or 100″ will be described. FIGS. 2A and 2B are diagrams illustrating exemplary hardware configurations of the image processing device and the server device.

Among them, FIG. 2A is a diagram illustrating an exemplary hardware configuration of the image processing device 120 of the image processing system 100′ or 100″. The image processing device 120 includes a processor 201, a memory 202, an auxiliary storage device 203, an interface (I/F) device 204, a communication device 205, and a drive device 206. Note that the respective pieces of hardware of the image processing device 120 are coupled to each other via a bus 207.

The processor 201 includes various arithmetic devices, such as a central processing unit (CPU), a graphics processing unit (GPU), and the like. The processor 201 reads various programs (e.g., image processing program, etc.) into the memory 202 and executes the programs.

The memory 202 includes a main storage device, such as a read only memory (ROM), a random access memory (RAM), or the like. The processor 201 and the memory 202 form what is called a computer, and the processor 201 executes the various programs read into the memory 202, thereby causing the computer to implement various functions.

The auxiliary storage device 203 stores various programs and various types of data to be used when the various programs are executed by the processor 201.

The I/F device 204 is a coupling device that couples the hierarchical encoding device 111, which is an exemplary external device, to the image processing device 120.

The communication device 205 is a communication device for communicating with the server device 130 via a network.

The drive device 206 is a device for setting a recording medium 210. The recording medium 210 mentioned here includes a medium that optically, electrically, or magnetically records information, such as a compact disc read only memory (CD-ROM), a flexible disk, a magneto-optical disk, or the like. Alternatively, the recording medium 210 may include a semiconductor memory or the like that electrically records information, such as a ROM, a flash memory, or the like.

Note that the various programs to be installed in the auxiliary storage device 203 are installed when, for example, the distributed recording medium 210 is set in the drive device 206, and the various programs recorded in the recording medium 210 are read by the drive device 206. Alternatively, the various programs to be installed in the auxiliary storage device 203 may be installed by being downloaded from the network 140 via the communication device 205.

Meanwhile, FIG. 2B is a diagram illustrating an exemplary hardware configuration of the server device 130 of the image processing system 100 or the server device 130 of the image processing system 100′ or 100″. Note that, since the hardware configuration of the server device 130 is roughly the same as the hardware configuration of the image processing device 120 illustrated in FIG. 2A, differences from the image processing device 120 illustrated in FIG. 2A will be mainly described here.

A processor 221 reads, for example, the image processing program, the image recognition program, and the like into a memory 222, and executes the programs.

An I/F device 224 receives an operation performed on the server device 130 via an operation device 231. Furthermore, the I/F device 224 outputs a result of processing performed by the server device 130, and displays it via a display device 232. Furthermore, a communication device 225 communicates with the hierarchical encoding device 111 or the image processing device 120 via the network 140.

Note that, hereinafter, details of the functional configuration of each device (details of the functional configuration of the hierarchical encoding device 111, the functional configuration of the transcode unit 121 of the server device 130, etc. in the image processing system 100) and the like in the case of the system configuration illustrated in FIG. 1A will be described to simplify the description.

### <Functional Configuration of Hierarchical Encoding Device>

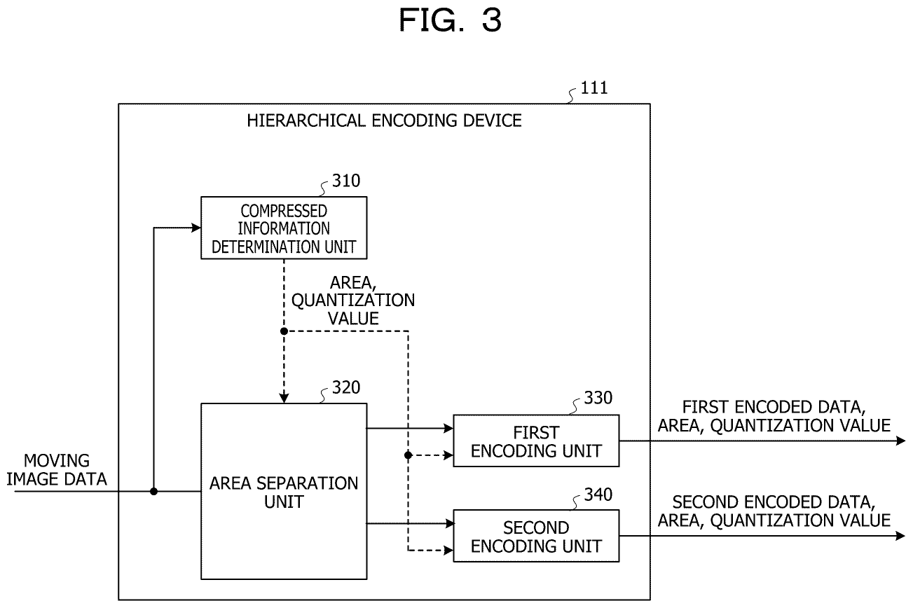

First, a functional configuration of the hierarchical encoding device 111 of the image processing system 100 will be described with reference to FIG. 3. FIG. 3 is a first diagram illustrating an exemplary functional configuration of the hierarchical encoding device.

A hierarchical encoding program is installed in the hierarchical encoding device 111, and execution of the program causes the hierarchical encoding device 111 to function as a compressed information determination unit 310, an area separation unit 320, a first encoding unit 330, and a second encoding unit 340.

The compressed information determination unit 310 is an exemplary determination unit. The compressed information determination unit 310 repeats encoding and decoding of image data of each frame included in the moving image data while changing the quantization value, and performs recognition processing using AI on each piece of the decoded data to determine whether or not the recognition target has been recognized. As a result, the compressed information determination unit 310 determines a quantization value (limit quantization value) of a limit needed for the AI to recognize the recognition target, and also determines a target area needed for the AI to recognize the recognition target.

When the recognition target is included in the image data, the compressed information determination unit 310 performs processing of:
notifying the area separation unit 320 of the determined target area and the non-target area derived from the determined target area, and also notifying each of the first encoding unit 330 and the second encoding unit 340; and
notifying the first encoding unit 330 of the determined limit quantization value, and notifying the second encoding unit 340 of a predetermined quantization value (quantization value suitable for encoding the non-target area).

Furthermore, when the recognition target is not included in the image data, the compressed information determination unit 310 performs processing of:
notifying the area separation unit 320 of all the areas, and also notifying the first encoding unit 330 and the second encoding unit 340; and
notifying the first encoding unit 330 and the second encoding unit 340 of a predetermined quantization value.

The area separation unit 320 separates the image data of each frame included in the moving image data based on the target area and the non-target area notified from the compressed information determination unit 310. For example, the area separation unit 320 separates the image data of each frame included in the moving image data into the following items:
first image data including an image of the target area and an invalid image of the non-target area; and
second image data including an invalid image of the target area and an image of the non-target area. Note that the invalid image refers to an image in which a pixel value of each pixel is a predetermined pixel value (e.g., pixel value corresponding to black, etc.).

Furthermore, with respect to the separated image data, the area separation unit 320 performs processing of:
notifying the first encoding unit 330 of the first image data including the image of the target area and the invalid image of the non-target area; and
notifying the second encoding unit 340 of the second image data including the invalid image of the target area and the image of the non-target area.

Note that, when all the areas have been notified from the compressed information determination unit 310, the area separation unit 320 performs processing of:
notifying the first encoding unit 330 of the first image data in which all the areas are set as an invalid image; and
notifying the second encoding unit 340 of the second image data including an image of all the areas.

The first encoding unit 330 is an example of a first encodement unit, which encodes the first image data notified from the area separation unit 320 using the limit quantization value (or predetermined quantization value) notified from the compressed information determination unit 310, and generates the first encoded data. Furthermore, the first encoding unit 330 transmits, to the server device 130, the information regarding the target area (or all the areas) and the limit quantization value (or predetermined quantization value) notified from the compressed information determination unit 310 in a manner of being included in the generated first encoded data.

The second encoding unit 340 is an example of a second encodement unit, which encodes the second image data notified from the area separation unit 320 using the predetermined quantization value notified from the compressed information determination unit 310, and generates the second encoded data. Furthermore, the second encoding unit 340 transmits, to the server device 130, the information regarding the non-target area (or all the areas) and the predetermined quantization value notified from the compressed information determination unit 310 in a manner of being included in the generated second encoded data.

Note that any method may be adopted as a method by which the first encoding unit 330 includes the information regarding the target area (or all the areas) and the limit quantization value (or predetermined quantization value) in the first encoded data. Likewise, any method may be adopted as a method by which the second encoding unit 340 includes the information regarding the non-target area (or all the areas) and the predetermined quantization value in the second encoded data.

As an example, a method of including the above-described information in a part of a payload or a header that may be defined by the user in a packet, such as a real-time transport protocol (RTP), is exemplified. Furthermore, as another example, a method of including the above-described information in the NAL number that may be used by the user (use application is not determined in standards) is exemplified when the encoding scheme is HEVC or the like.

### <Functional Configuration of Transcode Unit>

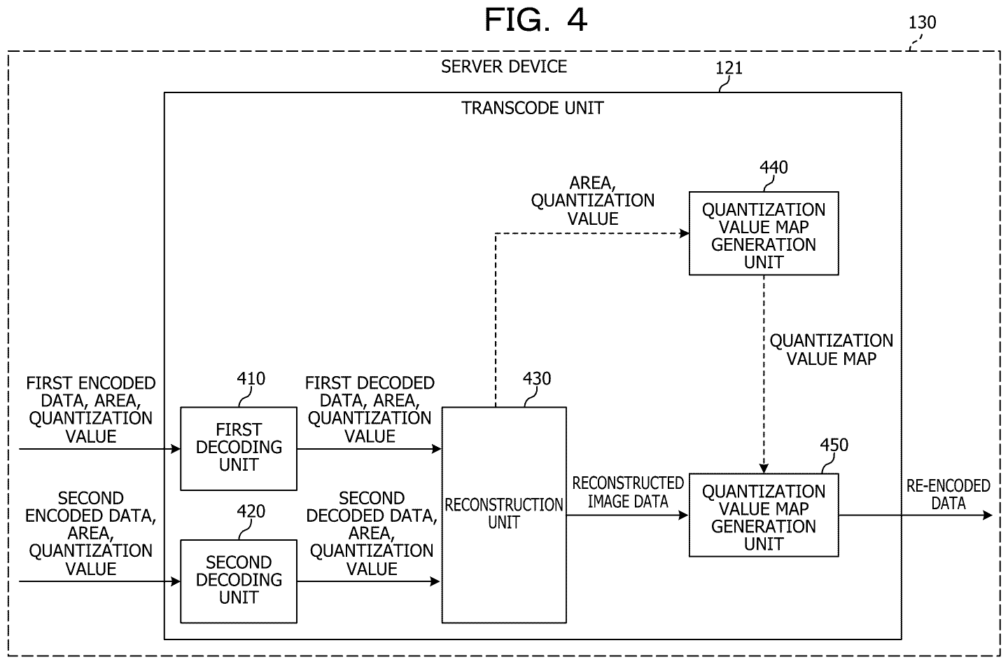

Next, a functional configuration of the transcode unit 121 of the server device 130 in the image processing system 100 will be described with reference to FIG. 4. FIG. 4 is a first diagram illustrating an exemplary functional configuration of the transcode unit.

As illustrated in FIG. 4, the transcode unit 121 includes a first decoding unit 410, a second decoding unit 420, a reconstruction unit 430, a quantization value map generation unit 440, and a re-encoding unit 450.

The first decoding unit 410 receives the first encoded data (including the information regarding the area and the quantization value) transmitted from the hierarchical encoding device 111, and decodes the received first encoded data, thereby generating first decoded data. Furthermore, the first decoding unit 410 notifies the reconstruction unit 430 of the generated first decoded data together with the information regarding the area and the quantization value.

The second decoding unit 420 receives the second encoded data (including the information regarding the area and the quantization value) transmitted from the hierarchical encoding device 111, and decodes the received second encoded data, thereby generating second decoded data. Furthermore, the second decoding unit 420 notifies the reconstruction unit 430 of the generated second decoded data together with the information regarding the area and the quantization value.

The reconstruction unit 430 extracts an image of the target area from the first decoded data notified from the first decoding unit 410 based on the information regarding the area. Furthermore, the reconstruction unit 430 extracts an image of the non-target area from the second decoded data notified from the second decoding unit 420 based on the information regarding the area. Furthermore, the reconstruction unit 430 combines the extracted image of the target area and the extracted image of the non-target area to generate reconstructed image data.

Furthermore, the reconstruction unit 430 notifies the re-encoding unit 450 of the generated reconstructed image data. Moreover, the reconstruction unit 430 notifies the quantization value map generation unit 440 of the following items:
information regarding the area and the quantization value (target area and limit quantization value) notified from the first decoding unit 410; and
information regarding the area and the quantization value (non-target area and predetermined quantization value) notified from the second decoding unit 420.

The quantization value map generation unit 440 generates a quantization value map based on the information regarding the area and the quantization value notified from the reconstruction unit 430. The quantization value map generation unit 440 generates the quantization value map by setting the limit quantization value or a quantization value close to the limit quantization value in the target area and setting a predetermined quantization value in the non-target area.

Furthermore, the quantization value map generation unit 440 notifies the re-encoding unit 450 of the generated quantization value map.

The re-encoding unit 450 is an example of a re-encodement unit, which performs encoding processing on the reconstructed image data notified from the reconstruction unit 430 using the quantization value map notified from the quantization value map generation unit 440, and generates re-encoded data. Note that the re-encoding unit 450 is assumed to have a function of performing encoding processing using a different quantization value for each area. Furthermore, the re-encoding unit 450 notifies the re-encoded data acquisition unit 131 of the generated re-encoded data.

As described above, the transcode unit 121 generates the quantization value map based on the information regarding the area and the quantization value determined by the hierarchical encoding device 111. As a result, according to the image processing system 100 according to the first embodiment, equal image quality may be maintained before and after the transcode unit 121.

Note that the encoding scheme used when the re-encoding unit 450 performs the encoding processing may be the same as or different from the encoding scheme used when the first encoding unit 330 and the second encoding unit 340 perform the encoding processing. For example, the encoding scheme used when the first encoding unit 330 and the second encoding unit 340 perform the encoding processing may be H.265/HEVC, and the encoding scheme used when the re-encoding unit 450 performs the encoding processing may be H.264/MPEG-4 AVC.

Furthermore, the specification of the re-encoding unit 450 may be the same as or different from the specifications of the first encoding unit 330 and the second encoding unit 340.

Note that the information regarding the area is not necessarily exchanged when a plurality of encoding units (e.g., first encoding unit 330 and second encoding unit 340) and a plurality of decoding units (e.g., first decoding unit 410 and second decoding unit 420) are used.

For example, the information regarding the area exchanged between one of the encoding units and decoding units may be derived when the information regarding the area exchanged between another one of the encoding units and decoding units is used. In such a case, the information regarding the area is not necessarily exchanged between the one of the encoding units and decoding units.

### Specific Processing Example of Hierarchical Encoding Device and Transcode Unit

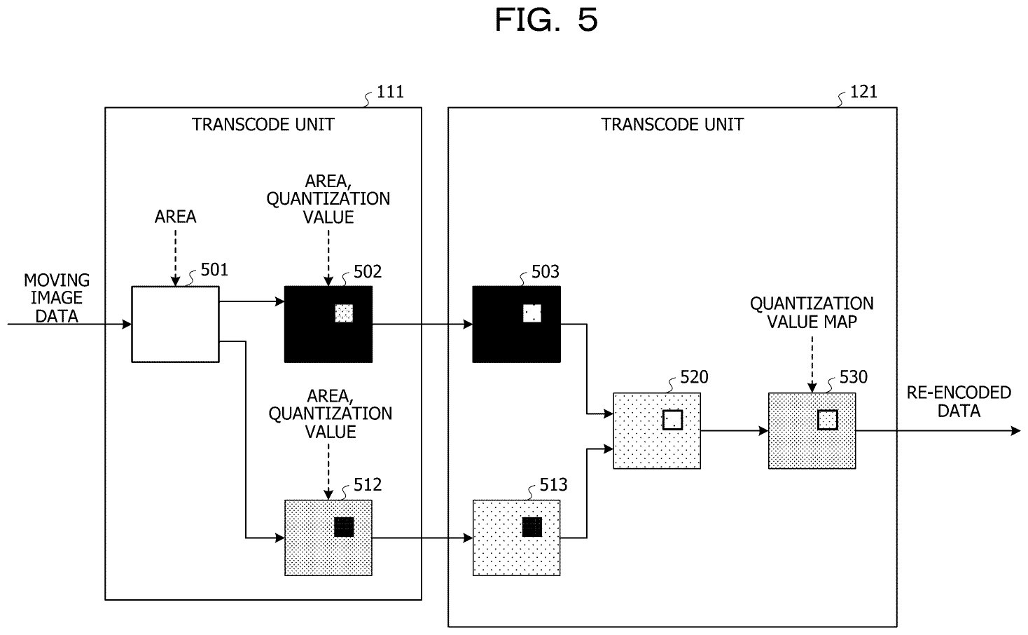

Next, a specific example of processing of the hierarchical encoding device 111 and the transcode unit 121 will be described. FIG. 5 is a first diagram illustrating a specific example of the processing of the hierarchical encoding device and the transcode unit.

In FIG. 5, image data 501 is image data for one frame included in the moving image data. As illustrated in FIG. 5, the area separation unit 320 separates the obtained image data 501 into the following items:
first image data including an image of the target area and an invalid image of the non-target area; and
second image data including an invalid image of the target area and an image of the non-target area,

and the following processing is performed:
first encoded data 502 is generated by the first encoding unit 330 encoding the first image data including the image of the target area and the invalid image of the non-target area using the limit quantization value; and
second encoded data 512 is generated by the second encoding unit 340 encoding the second image data including the invalid image of the target area and the image of the non-target area using a predetermined quantization value.

Furthermore, as illustrated in FIG. 5, the first encoded data 502 generated by the first encoding unit 330 is transmitted to the transcode unit 121, and is decoded by the first decoding unit 410, thereby generating first decoded data 503.

Likewise, the second encoded data 512 generated by the second encoding unit 340 is transmitted to the transcode unit 121, and is decoded by the second decoding unit 420, thereby generating second decoded data 513.

Furthermore, as illustrated in FIG. 5, the reconstruction unit 430 extracts the image of the target area from the first decoded data 503, and the reconstruction unit 430 extracts the image of the non-target area from the second decoded data 513. Furthermore, the reconstruction unit 430 combines the extracted image of the target area and the extracted image of the non-target area, thereby generating reconstructed image data 520.

Furthermore, as illustrated in FIG. 5, the re-encoding unit 450 encodes the generated reconstructed image data 520 using the quantization value map, thereby generating re-encoded data 530. The example of FIG. 5 illustrates a state in which the re-encoding unit 450 encodes the target area with the limit quantization value and encodes the non-target area with the predetermined quantization value with respect to the reconstructed image data 520.

### <Image Processing Flow in Image Processing System>

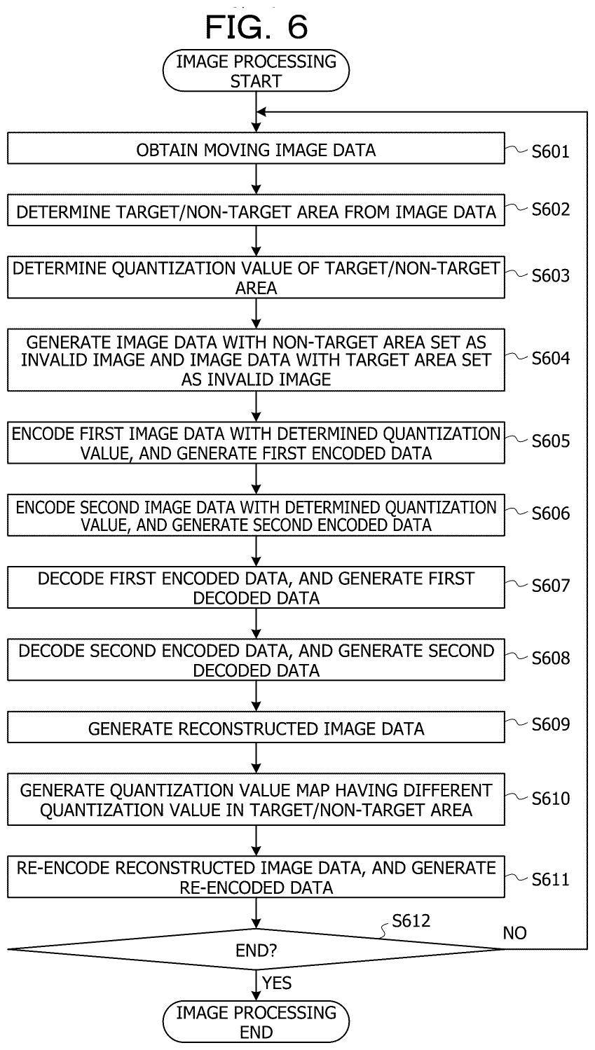

Next, a flow of the image processing by the image processing system 100 will be described. FIG. 6 is a first flowchart illustrating a flow of the image processing.

In step S601, the imaging device 110 obtains moving image data.

In step S602, the hierarchical encoding device 111 determines a target area and a non-target area for the image data of each frame included in the moving image data.

In step S603, the hierarchical encoding device 111 determines a limit quantization value of the target area and a predetermined quantization value of the non-target area with respect to the image data of each frame included in the moving image data.

In step S604, the hierarchical encoding device 111 generates first image data including an image of the target area and an invalid image of the non-target area, and second image data including an invalid image of the target area and an image of the non-target area.

In step S605, the hierarchical encoding device 111 encodes the first image data with the determined limit quantization value, and generates first encoded data. Furthermore, the hierarchical encoding device 111 transmits, to the server device 130, the generated first encoded data including information regarding the area and the quantization value.

In step S606, the hierarchical encoding device 111 encodes the second image data with the determined predetermined quantization value, and generates second encoded data. Furthermore, the hierarchical encoding device 111 transmits, to the server device 130, the generated second encoded data including the information regarding the area and the quantization value.

In step S607, the transcode unit 121 of the server device 130 decodes the first encoded data, and generates first decoded data.

In step S608, the transcode unit 121 of the server device 130 decodes the second encoded data, and generates second decoded data.

In step S609, the transcode unit 121 of the server device 130 combines the image of the target area of the first decoded data and the image of the non-target area of the second decoded data to generate reconstructed image data.

In step S610, the transcode unit 121 of the server device 130 generates a quantization value map having different quantization values in the target area and the non-target area based on the information regarding the area and the quantization value included in the first encoded data and the second encoded data.

In step S611, the transcode unit 121 of the server device 130 re-encodes the reconstructed image data using the quantization value map, and generates re-encoded data.

In step S612, the imaging device 110 determines whether or not to terminate the image processing. If it is determined in step S612 that the image processing is not to be terminated (in the case of NO in step S612), the process returns to step S601.

On the other hand, if it is determined in step S612 that the image processing is to be terminated (in the case of YES in step S612), the image processing is terminated.

As is clear from the descriptions above, the image processing system 100 according to the first embodiment includes the transcode unit 121, and integrates the first encoded data and the second encoded data transmitted from the hierarchical encoding device 111 to generate the re-encoded data.

Thus, according to the image processing system 100 according to the first embodiment, the first encoded data and the second encoded data are not directly input to the re-encoded data acquisition unit 131. As a result, according to the image processing system 100 according to the first embodiment, a function of receiving two types of encoded data and a function of reconstruction do not need to be incorporated into the image recognition program of the server device 130.

For example, according to the first embodiment, the image processing system, the image processing method, and the image processing program suitable for transmitting images used for the recognition processing by the AI in the server device may be provided.

### Second Embodiment

In the first embodiment described above, it has been described that the quantization value map generation unit 440 generates the quantization value map based on the information regarding the area and the quantization value notified from the reconstruction unit 430. However, the method of generating the quantization value map by the quantization value map generation unit 440 is not limited to this, and for example, a non-effective area, which is not effective to be displayed by the video display unit 133 in the image of the non-target area, may be re-encoded with the maximum quantization value. Alternatively, the non-effective area, which is not effective to be displayed by the video display unit 133 in the image of the non-target area, may be set as an invalid image in the reconstruction unit 430, and then re-encoded with any quantization value. Hereinafter, a second embodiment will be described focusing on differences from the first embodiment described above.

### <Functional Configuration of Transcode Unit>

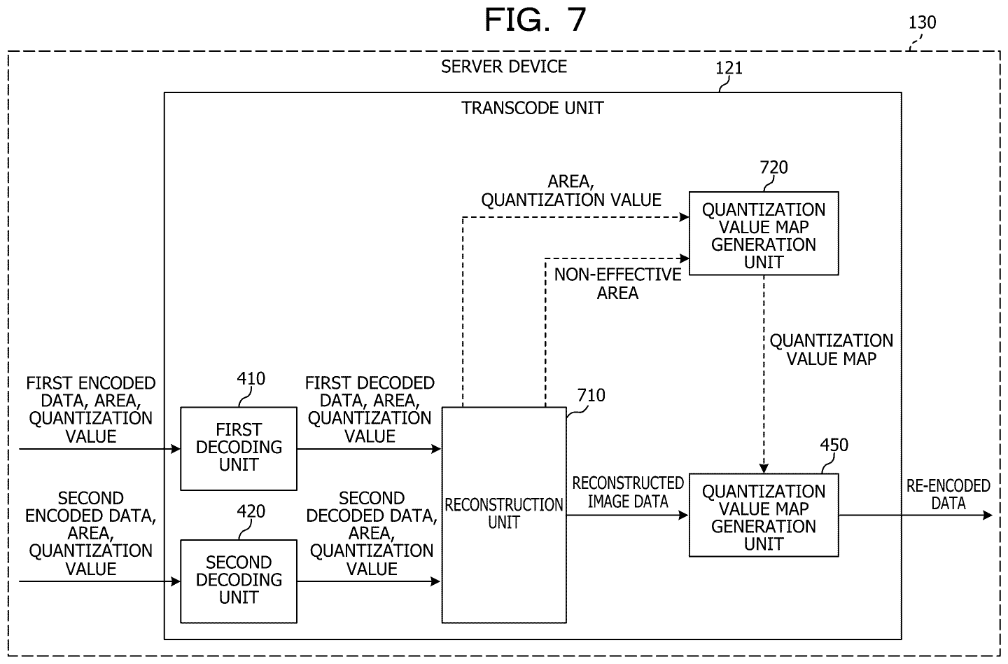

First, a functional configuration of a transcode unit 121 of a server device 130 in an image processing system 100 according to the second embodiment will be described with reference to FIG. 7. FIG. 7 is a second diagram illustrating an exemplary functional configuration of the transcode unit.

A difference from FIG. 4 is that functions of a reconstruction unit 710 and a quantization value map generation unit 720 are difference from the functions of the reconstruction unit 430 and the quantization value map generation unit 440 illustrated in FIG. 4.

The reconstruction unit 710 extracts an image of a target area from first decoded data notified from a first decoding unit 410 based on information regarding an area. Furthermore, the reconstruction unit 710 extracts an image of a non-target area from second decoded data notified from a second decoding unit 420 based on the information regarding the area. Furthermore, the reconstruction unit 710 combines the extracted image of the target area and the extracted image of the non-target area to generate reconstructed image data.

Furthermore, the reconstruction unit 710 notifies a re-encoding unit 450 of the generated reconstructed image data, and also notifies the quantization value map generation unit 720 of the following items:
information regarding the area and the quantization value (target area and limit quantization value) notified from the first decoding unit 410; and
information regarding the area and the quantization value (non-target area and predetermined quantization value) notified from the second decoding unit 420.

Moreover, when a non-effective area, which is not effective to be displayed by a video display unit 133, is designated in the image of the non-target area, the reconstruction unit 710 notifies the quantization value map generation unit 720 of the non-effective area.

Alternatively, when the non-effective area, which is not effective to be displayed by the video display unit 133, is designated in the image of the non-target area, the reconstruction unit 710 generates reconstructed image data with the non-effective area as an invalid image, and notifies the re-encoding unit 450.

The quantization value map generation unit 720 generates a quantization value map based on the information regarding the area and the quantization value notified from the reconstruction unit 710. The quantization value map generation unit 720 generates the quantization value map by setting the limit quantization value or a quantization value close to the limit quantization value in the target area and setting a predetermined quantization value in the non-target area.

Furthermore, when the non-effective area is notified from the reconstruction unit 710, the quantization value map generation unit 720 changes the quantization value of the notified non-effective area in the generated quantization value map to the maximum quantization value.

Moreover, the quantization value map generation unit 720 notifies the re-encoding unit 450 of the changed quantization value map.

Note that, when the reconstructed image data in which the non-effective area is set as the invalid image is notified from the reconstruction unit 710, the re-encoding unit 450 generates re-encoded data using the quantization value map generated by the quantization value map generation unit 720.

Furthermore, when the reconstructed image data is notified from the reconstruction unit 710, the re-encoding unit 450 generates re-encoded data using the changed quantization value map changed by the quantization value map generation unit 720.

As described above, by setting the maximum quantization value in the non-effective area (or setting the non-effective area as the invalid image), according to the image processing system 100 according to the second embodiment,
re-encoded data having data volume smaller than that of first encoded data and second encoded data is stored, whereby the stored data volume stored in the server device 130 may be further reduced.

### Specific Processing Example of Hierarchical Encoding Device and Transcode Unit

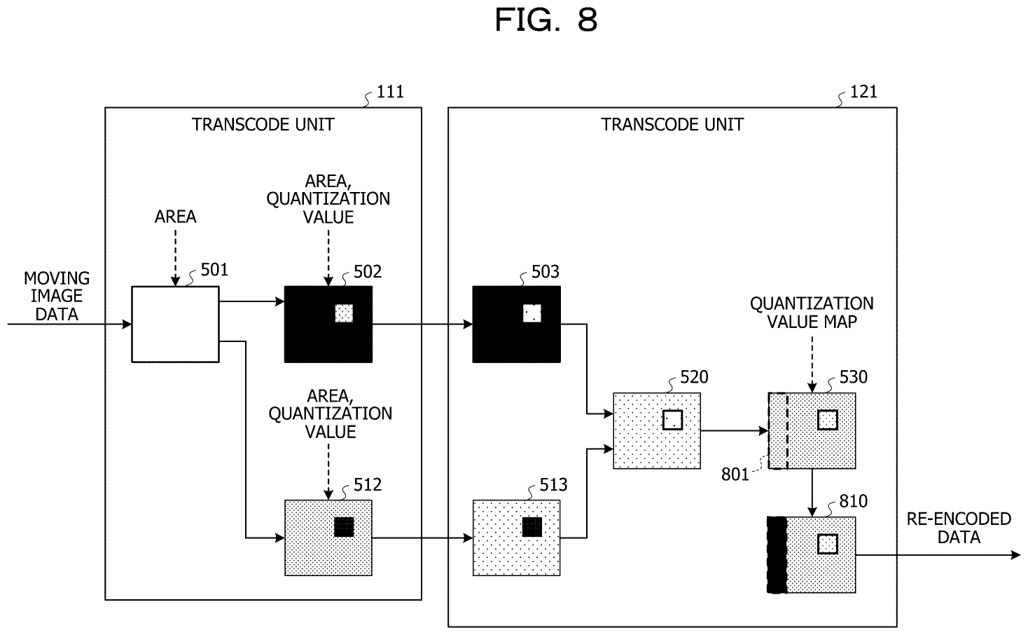

Next, a specific example of processing of the hierarchical encoding device 111 and the transcode unit 121 will be described. FIG. 8 is a second diagram illustrating a specific example of the processing of the hierarchical encoding device and the transcode unit.

A difference from FIG. 5 is that a non-effective area 801 is designated at a time of generating re-encoded data 530 so that the non-effective area 801 is encoded with the maximum quantization value (alternatively, the non-effective area 801 is set as an invalid image, and then encoded with any quantization value). In addition, a difference from FIG. 5 is that re-encoded data 810 is generated in the case of FIG. 8.

### <Image Processing Flow in Image Processing System>

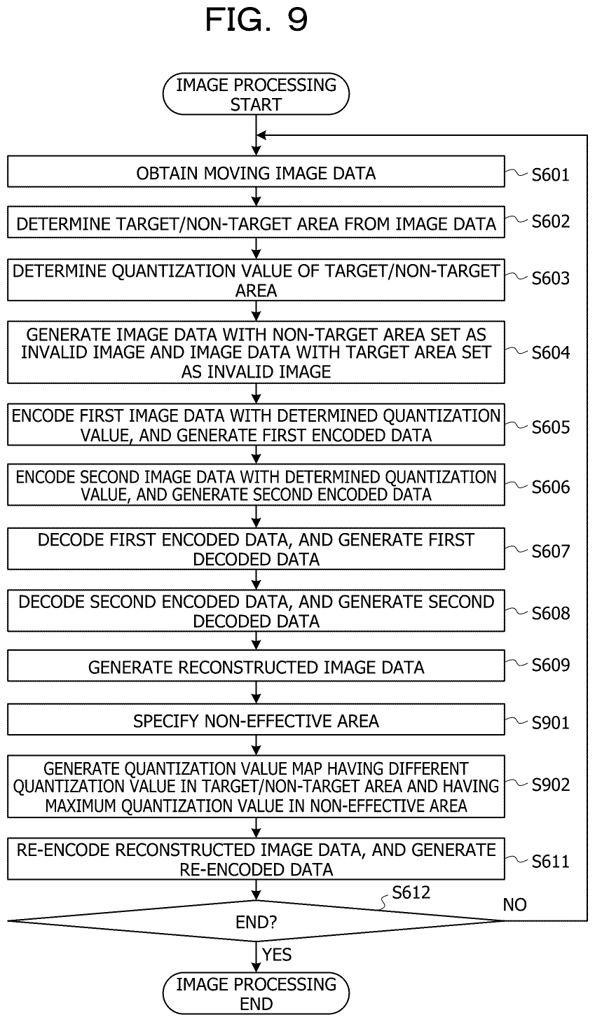

Next, a flow of the image processing by the image processing system 100 will be described. FIG. 9 is a second flowchart illustrating the flow of the image processing. Differences from FIG. 6 are step S901 and step S902.

In step S901, the transcode unit 121 of the server device 130 specifies the non-effective area, which is not effective to be displayed by the video display unit 133, in the image of the non-target area.

In step S902, the transcode unit 121 of the server device 130 generates a quantization value map having different quantization values in the target area and the non-target area based on the information regarding the area and the quantization value included in the first encoded data and the second encoded data. Furthermore, the transcode unit 121 of the server device 130 changes the quantization value map such that the quantization value of the specified non-effective area becomes the maximum quantization value. Alternatively, the transcode unit 121 of the server device 130 generates reconstructed image data in which the specified non-effective area is set as an invalid image.

As is clear from the descriptions above, the image processing system 100 according to the second embodiment sets the quantization value of the non-effective area to the maximum quantization value (or sets the non-effective area as the invalid image). As a result, according to the image processing system 100 according to the second embodiment, the stored data volume stored in the server device 130 may be further reduced.

For example, according to the second embodiment, the stored data volume may be further reduced while exerting the effects similar to those of the first embodiment described above.

### Third Embodiment

In the first and second embodiments described above, the case has been described in which the hierarchical encoding device 111 transmits the information regarding the area and the quantization value, which is in a manner of being included in each of the first encoded data and the second encoded data, to the server device 130. However, the method of transmitting the information regarding the area and the quantization value is not limited to this, and for example, the information may be transmitted to the server device 130 separately from the first encoded data and the second encoded data. Hereinafter, a third embodiment will be described focusing on differences from the first and second embodiments described above.

### <Functional Configuration of Hierarchical Encoding Device>

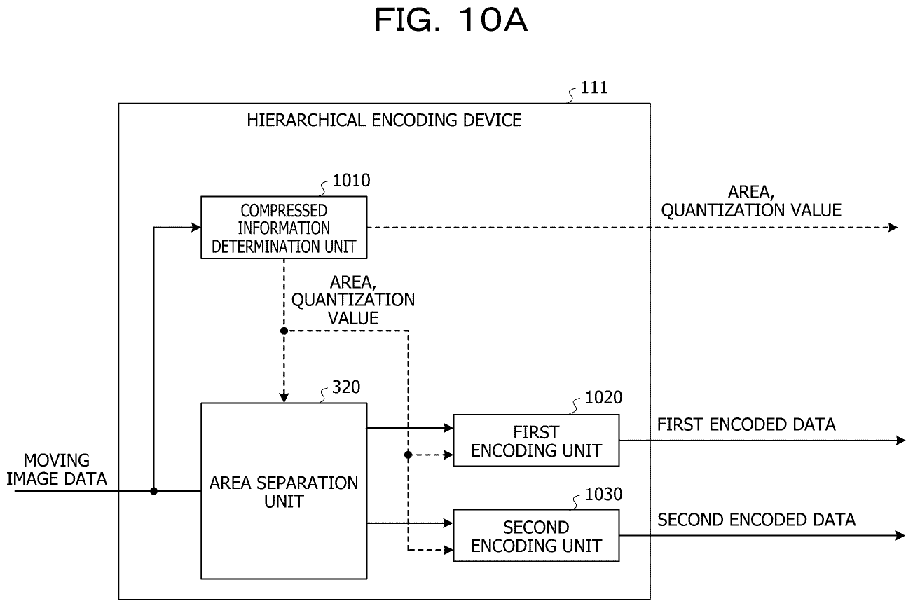

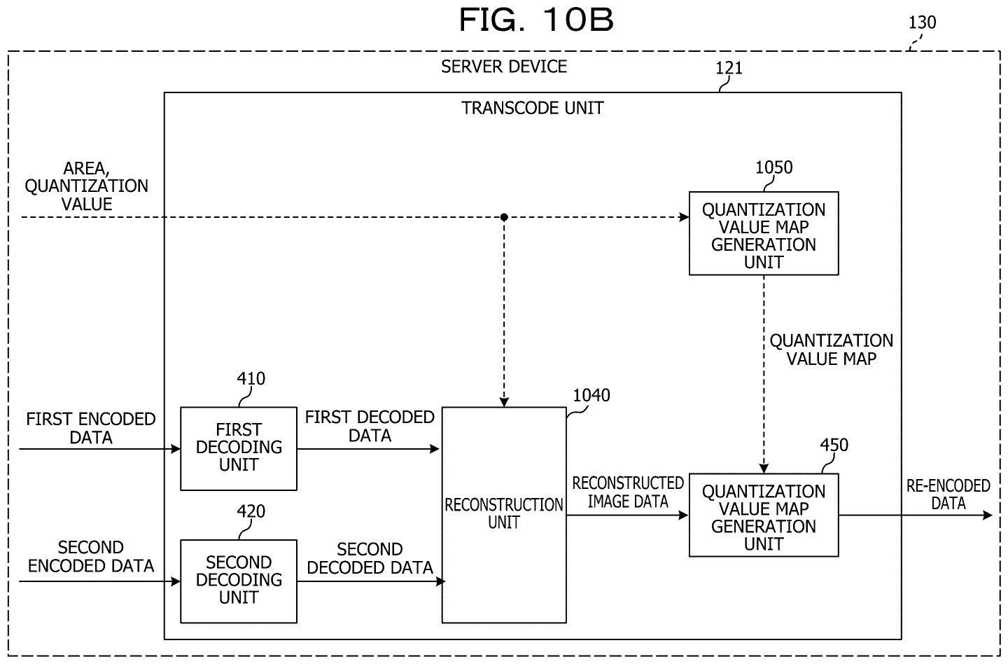

First, a functional configuration of a hierarchical encoding device 111 of an image processing system 100 according to the third embodiment will be described with reference to FIG. 10A. FIG. 10A is a second diagram illustrating an exemplary functional configuration of the hierarchical encoding device.

A difference from FIG. 3 is that functions of a compressed information determination unit 1010, a first encoding unit 1020, and a second encoding unit 1030 are different from the functions of the compressed information determination unit 310, the first encoding unit 330, and the second encoding unit 340 illustrated in FIG. 3.

The compressed information determination unit 1010 repeats encoding and decoding of image data of each frame included in moving image data while changing a quantization value, and performs recognition processing using AI on each piece of decoded data to determine whether or not a recognition target has been recognized. As a result, the compressed information determination unit 1010 determines a limit quantization value needed for the AI to recognize the recognition target, and also determines a target area needed for the AI to recognize the recognition target.

Furthermore, when the recognition target is included in the image data, the compressed information determination unit 1010 performs processing of:
notifying an area separation unit 320 of the determined target area and a non-target area derived from the determined target area, and transmitting, to a server device 130, the target area and the non-target area in association with first encoded data as information regarding the area; and
notifying the first encoding unit 1020 of the determined limit quantization value, and transmitting, to the server device 130, the limit quantization value in association with the first encoded data as information regarding the quantization value. Furthermore, the second encoding unit 1030 is notified of the determined predetermined quantization value, and the predetermined quantization value in association with second encoded data is transmitted to the server device 130 as the information regarding the quantization value.

Furthermore, when the recognition target is not included in the image data, the compressed information determination unit 1010 performs processing of:
notifying the area separation unit 320 of all areas, and transmitting, to the server device 130, all the areas in association with the first encoded data and the second encoded data as the information regarding the area; and
notifying the first encoding unit 1020 and the second encoding unit 1030 of the determined predetermined quantization value, and transmitting, to the server device 130, the predetermined quantization value in association with the first encoded data and the second encoded data as the information regarding the quantization value.

The first encoding unit 1020 encodes first image data notified from the area separation unit 320 using the limit quantization value (or predetermined quantization value) notified from the compressed information determination unit 1010, and generates the first encoded data. Furthermore, the first encoding unit 1020 transmits the generated first encoded data to the server device 130.

The second encoding unit 1030 encodes second image data notified from the area separation unit 320 using the predetermined quantization value notified from the compressed information determination unit 1010, and generates the second encoded data. Furthermore, the second encoding unit 1030 transmits the generated second encoded data to the server device 130.

### <Functional Configuration of Transcode Unit>

Next, a functional configuration of a transcode unit 121 of the server device 130 in the image processing system 100 according to the third embodiment will be described with reference to FIG. 10B. FIG. 10B is a third diagram illustrating an exemplary functional configuration of the transcode unit.

A difference from FIG. 4 is that functions of a reconstruction unit 1040 and a quantization value map generation unit 1050 are difference from the functions of the reconstruction unit 430 and the quantization value map generation unit 440 in FIG. 4.

The reconstruction unit 1040 extracts an image of the target area from first decoded data based on the information regarding the area transmitted from the hierarchical encoding device 111. Furthermore, the reconstruction unit 1040 extracts an image of the non-target area from second decoded data based on the information regarding the area transmitted from the hierarchical encoding device 111. Furthermore, the reconstruction unit 1040 combines the extracted image of the target area and the extracted image of the non-target area to generate reconstructed image data. Moreover, the reconstruction unit 1040 notifies a re-encoding unit 450 of the generated reconstructed image data.

The quantization value map generation unit 1050 generates a quantization value map based on the information regarding the area and the quantization value transmitted from the hierarchical encoding device 111. The quantization value map generation unit 1050 generates the quantization value map by setting the limit quantization value or a quantization value close to the limit quantization value in the target area and setting a predetermined quantization value in the non-target area.

Furthermore, the quantization value map generation unit 1050 notifies the re-encoding unit 450 of the generated quantization value map.

### <Image Processing Flow in Image Processing System>

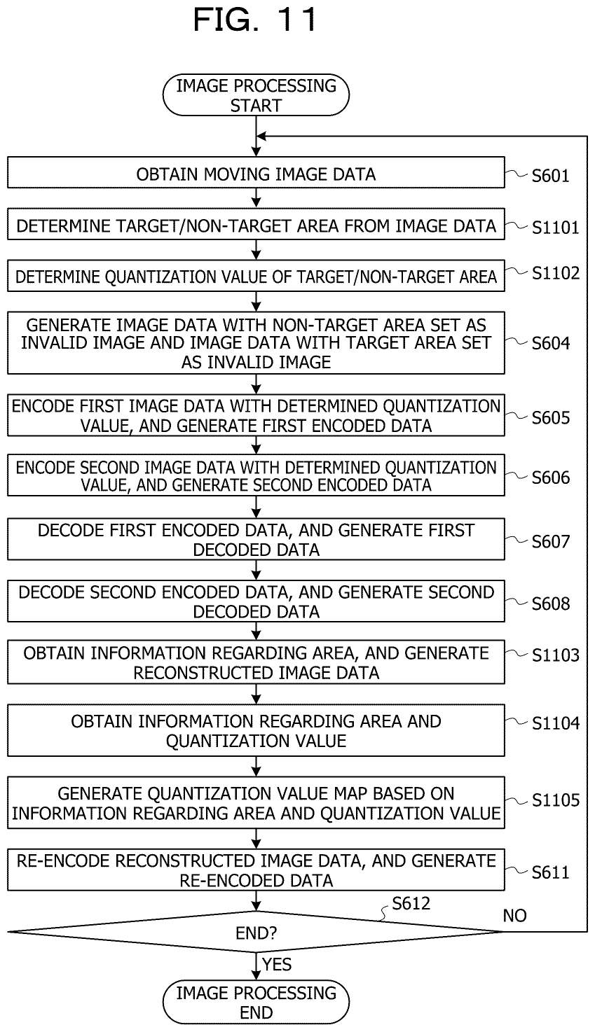

Next, a flow of image processing by the image processing system 100 according to the third embodiment will be described. FIG. 11 is a third flowchart illustrating the flow of the image processing. Differences from FIG. 6 are steps S1101, S1102, and S1103 to S1105.

In step S1101, the hierarchical encoding device 111 determines a target area and a non-target area for the image data of each frame included in the moving image, and transmits the determined target area and the non-target area to the server device 130 as information regarding the area.

In step S1102, the hierarchical encoding device 111 determines a limit quantization value of the target area and a predetermined quantization value of the non-target area with respect to the image data of each frame included in the moving image data. Furthermore, the hierarchical encoding device 111 transmits the determined limit quantization value and predetermined quantization value to the server device 130 as information regarding the quantization value.

In step S1103, the transcode unit 121 of the server device 130 extracts the image of the target area from the first decoded data, and extracts the image of the non-target area from the second decoded data based on the information regarding the area transmitted from the hierarchical encoding device 111. Furthermore, the transcode unit 121 of the server device 130 combines the extracted image of the target area and the extracted image of the non-target area to generate reconstructed image data.

In step S1104, the transcode unit 121 of the server device 130 obtains the information regarding the area and the quantization value transmitted from the hierarchical encoding device 111.

In step S1105, the transcode unit 121 of the server device 130 generates a quantization value map having different quantization values in the target area and the non-target area based on the obtained information regarding the area and the quantization value.

As is clear from the descriptions above, in the image processing system 100 according to the third embodiment, the hierarchical encoding device 111 transmits the information regarding the area and the quantization value to the server device 130 separately from the first encoded data and the second encoded data.

As a result, according to the image processing system 100 according to the third embodiment, effects similar to those of the first embodiment described above may be exerted.

### Fourth Embodiment

In each of the embodiments described above, the case has been described in which the quantization value map generation unit obtains the information regarding the area and the quantization value and generates the quantization value map based on the obtained information regarding the area and the quantization value. However, the method of generating the quantization value map is not limited to this.

For example, it is assumed that the compressed information determination unit 310 of the hierarchical encoding device 111 controls the quantization value by setting a bit rate in the first encoding unit 330 and the second encoding unit 340 instead of setting the quantization value in the first encoding unit 330 and the second encoding unit 340.

In this case, the reconstruction unit 430 is not enabled to obtain the information regarding the quantization value. In view of the above, in a fourth embodiment, first, a bit rate of first encoded data and second encoded data transmitted from a hierarchical encoding device 111 is obtained, and a re-bit rate of re-encoded data transmitted from a re-encoding unit 450 is determined. Subsequently, in the fourth embodiment, a quantization value map is generated such that the bit rate of the re-encoded data becomes the determined re-bit rate. Hereinafter, the fourth embodiment will be described focusing on differences from each of the embodiments described above.

### <Functional Configuration of Transcode Unit>

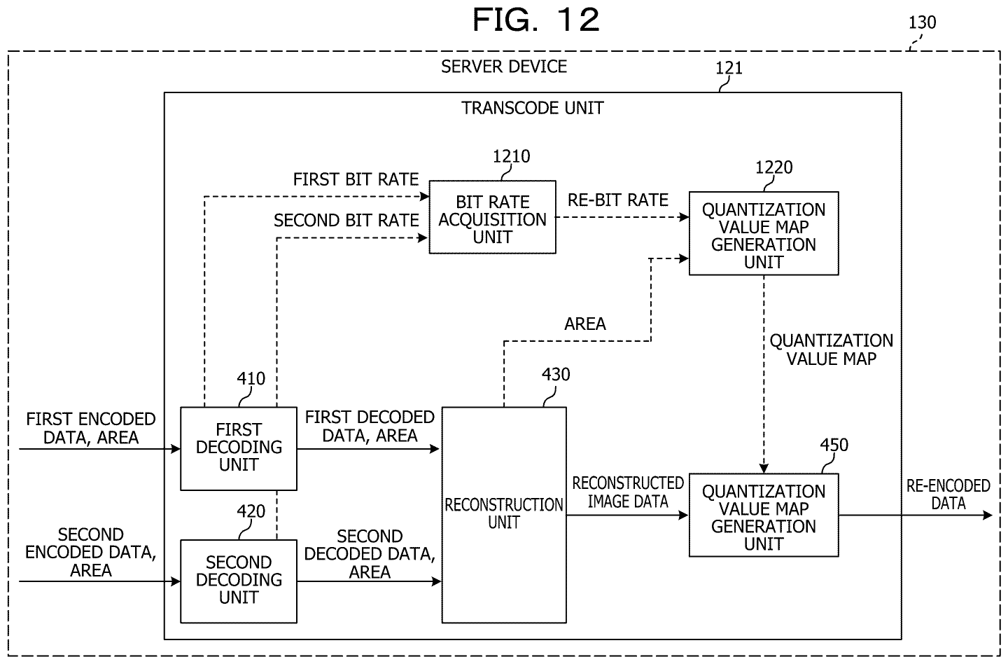

First, a functional configuration of a transcode unit 121 of a server device 130 in an image processing system 100 according to the fourth embodiment will be described with reference to FIG. 12. FIG. 12 is a fourth diagram illustrating an exemplary functional configuration of the transcode unit.

Differences from FIG. 4 are that a bit rate acquisition unit 1210 is included and that a function of a quantization value map generation unit 1220 is different from that of the quantization value map generation unit 440 illustrated in FIG. 4.

The bit rate acquisition unit 1210 obtains, from a first decoding unit 410, a bit rate (first bit rate) of the first encoded data transmitted from the hierarchical encoding device 111. Furthermore, the bit rate acquisition unit 1210 obtains, from a second decoding unit 420, a bit rate (second bit rate) of the second encoded data transmitted from the hierarchical encoding device 111.

Furthermore, the bit rate acquisition unit 1210 determines a re-bit rate of the re-encoded data transmitted from the re-encoding unit 450 based on the obtained first bit rate and second bit rate. Moreover, the bit rate acquisition unit 1210 notifies the quantization value map generation unit 1220 of the determined re-bit rate.

The quantization value map generation unit 1220 generates a quantization value map based on the re-bit rate determined by the bit rate acquisition unit 1210 and information regarding an area notified from a reconstruction unit 430. Furthermore, the quantization value map generation unit 1220 notifies the re-encoding unit 450 of the generated quantization value map.

### <Image Processing Flow in Image Processing System>

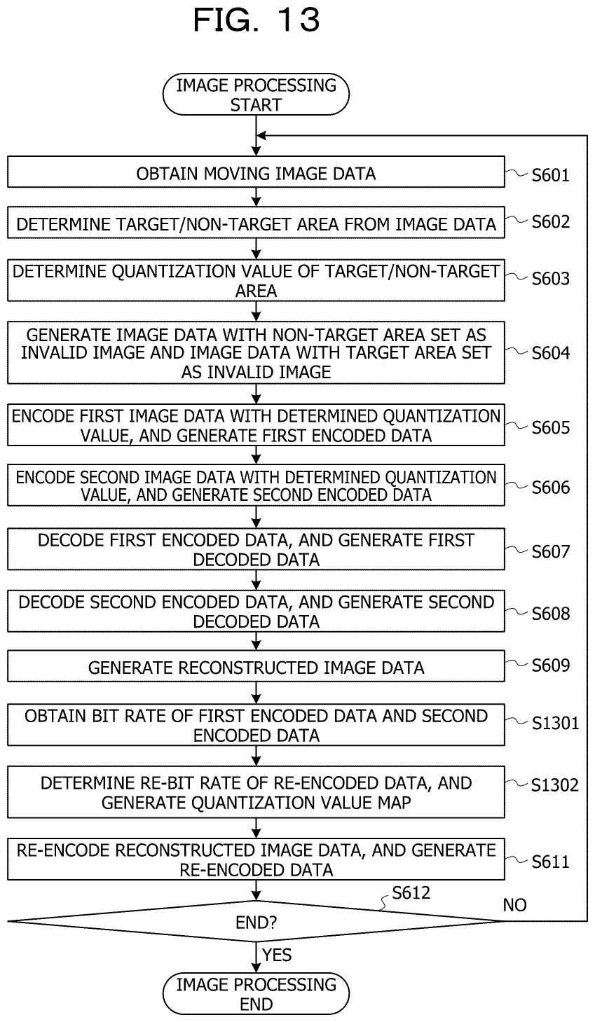

Next, a flow of image processing by the image processing system 100 according to the fourth embodiment will be described. FIG. 13 is a fourth flowchart illustrating the flow of the image processing. Differences from FIG. 6 are step S1301 and step S1302.

In step S1301, the transcode unit 121 of the server device 130 obtains the bit rates (first and second bit rates) of the first encoded data and the second encoded data transmitted from the hierarchical encoding device 111.

In step S1302, the transcode unit 121 of the server device 130 determines a re-bit rate of the re-encoded data based on the obtained bit rates (first and second bit rates). Furthermore, the transcode unit 121 of the server device 130 generates a quantization value map based on the determined re-bit rate and the information regarding the area.

As is clear from the descriptions above, in the image processing system 100 according to the fourth embodiment, the quantization value map generation unit generates the quantization value map from the re-bit rate determined based on the first bit rate and the second bit rate.

Thus, according to the image processing system 100 according to the fourth embodiment, the re-encoded data may be generated with the quantization value similar to that of the hierarchical encoding device 111 even when the information regarding the quantization value may not be obtained from the hierarchical encoding device 111. For example, according to the image processing system 100 according to the fourth embodiment, the bit rate may be maintained before and after the transcode unit 121.

As a result, according to the image processing system 100 according to the fourth embodiment, effects similar to those of the first embodiment described above may be exerted, and occurrence of a transmission delay may be avoided even when the information regarding the quantization value may not be obtained.

Note that, in the descriptions above, it has been described that the transcode unit 121 actually measures the first bit rate of the first encoded data and the second bit rate of the second encoded data.

However, the first bit rate and the second bit rate to be obtained by the bit rate acquisition unit 1210 are not limited to the actually measured bit rates. For example, the first bit rate and the second bit rate to be obtained by the bit rate acquisition unit 1210 may be bit rates set in a first encoding unit 330 and a second encoding unit 340 by a compressed information determination unit 310.

Furthermore, the first bit rate and the second bit rate to be obtained by the bit rate acquisition unit 1210 are not limited to the bit rates actually measured by the transcode unit 121. For example, the first bit rate and the second bit rate actually measured by the hierarchical encoding device 111 may be obtained by the bit rate acquisition unit 1210.

### Fifth Embodiment

In the fourth embodiment described above, the case has been described in which the quantization value map is generated based on the bit rates (first and second bit rates) of the first encoded data and the second encoded data transmitted from the hierarchical encoding device 111. However, the method of generating the quantization value map is not limited to this. For example, the quantization value map may be generated based on the information regarding the area and the quantization value, and the quantization value map may be further corrected based on the ratio between the bit rates (first and second bit rates) of the first encoded data and the second encoded data and the re-bit rate of the re-encoded data. Hereinafter, a fifth embodiment will be described focusing on differences from each of the embodiments described above.

### <Functional Configuration of Transcode Unit>

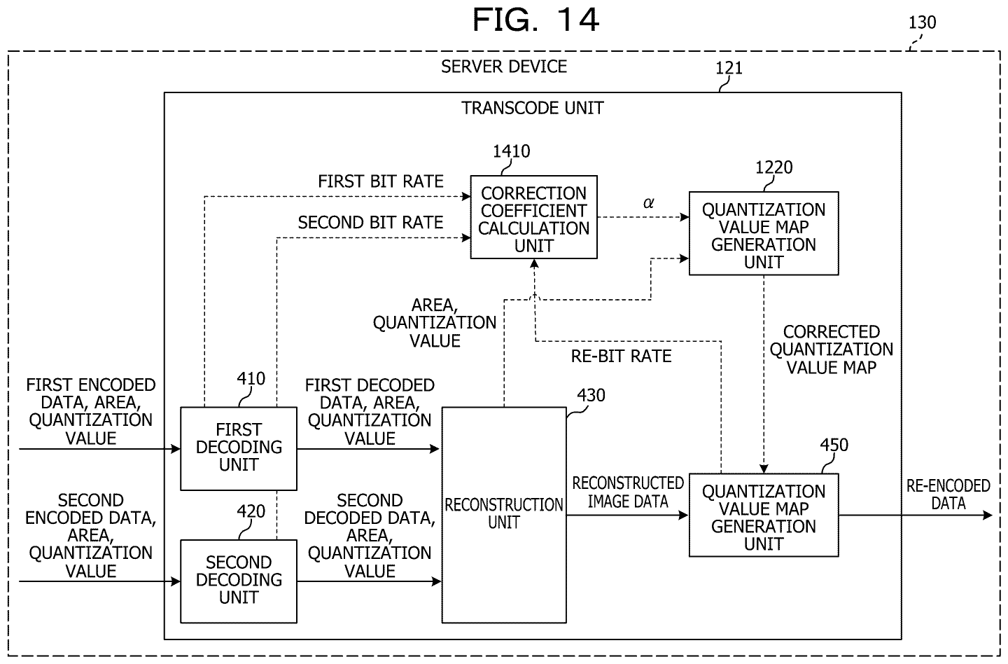

First, a functional configuration of a transcode unit 121 of a server device 130 in an image processing system 100 according to the fifth embodiment will be described with reference to FIG. 14. FIG. 14 is a fifth diagram illustrating an exemplary functional configuration of the transcode unit.

Differences from FIG. 4 are that a correction coefficient calculation unit 1410 is included and that a function of a quantization value map generation unit 1420 is different from that of the quantization value map generation unit 440 illustrated in FIG. 4.

The correction coefficient calculation unit 1410 obtains first bit rate, which is a bit rate of first encoded data, from a first decoding unit 410. Furthermore, the correction coefficient calculation unit 1410 obtains second bit rate, which is a bit rate of second encoded data, from a second decoding unit 420.

Furthermore, the correction coefficient calculation unit 1410 obtains a re-bit rate, which is a bit rate when a re-encoding unit 450 transmits re-encoded data to a re-encoded data acquisition unit 131.

Moreover, the correction coefficient calculation unit 1410 calculates a correction coefficient α at a time of correcting a quantization value map based on the obtained first bit rate, second bit rate, and re-bit rate, and notifies the quantization value map generation unit 1420.

The quantization value map generation unit 1420 generates a quantization value map based on information regarding an area and a quantization value notified from a reconstruction unit 430. At this time, the quantization value map generation unit 1420 generates the quantization value map by setting a limit quantization value or a quantization value close to the limit quantization value in a target area and setting a predetermined quantization value in a non-target area.

Furthermore, the quantization value map generation unit 1420 corrects the target area of the generated quantization value map using the correction coefficient α notified from the correction coefficient calculation unit 1410. Moreover, the quantization value map generation unit 1420 notifies the re-encoding unit 450 of the corrected quantization value map.

### Specific Processing Example of Correction Coefficient Calculation Unit

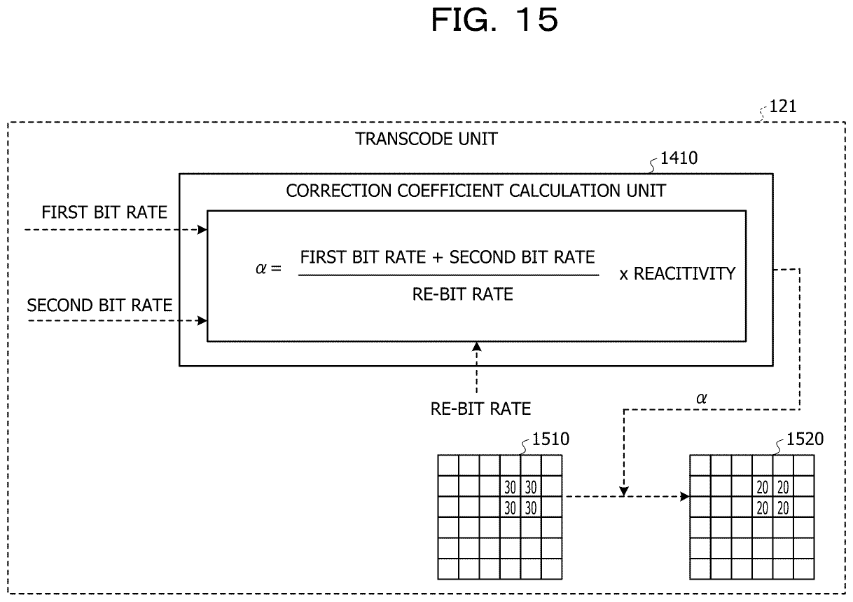

Next, a specific example of the processing of the correction coefficient calculation unit 1410 will be described. FIG. 15 is a diagram illustrating a specific example of the processing of the correction coefficient calculation unit. As illustrated in the example of FIG. 15, the correction coefficient calculation unit 1410 calculates the correction coefficient α based on the following equation (1).

$$[ Equation 1 ]$$

$$Correction coefficient a = \frac{first bit rate + second bit rate}{re - bit rate} \times reactivity \qquad Equation ( 1 )$$

Note that, in the equation (1) set out above, the reactivity is a parameter for gradually reflecting the ratio between the first bit rate and the second bit rate and the re-bit rate without directly reflecting the ratio in the quantization value.

As illustrated in FIG. 15, the correction coefficient α calculated by the correction coefficient calculation unit 1410 is multiplied to a target area of a quantization value map 1510 generated by the quantization value map generation unit 1420. As a result, the quantization value map 1510 is corrected, and a corrected quantization value map 1520 is generated.

### <Image Processing Flow in Image Processing System>

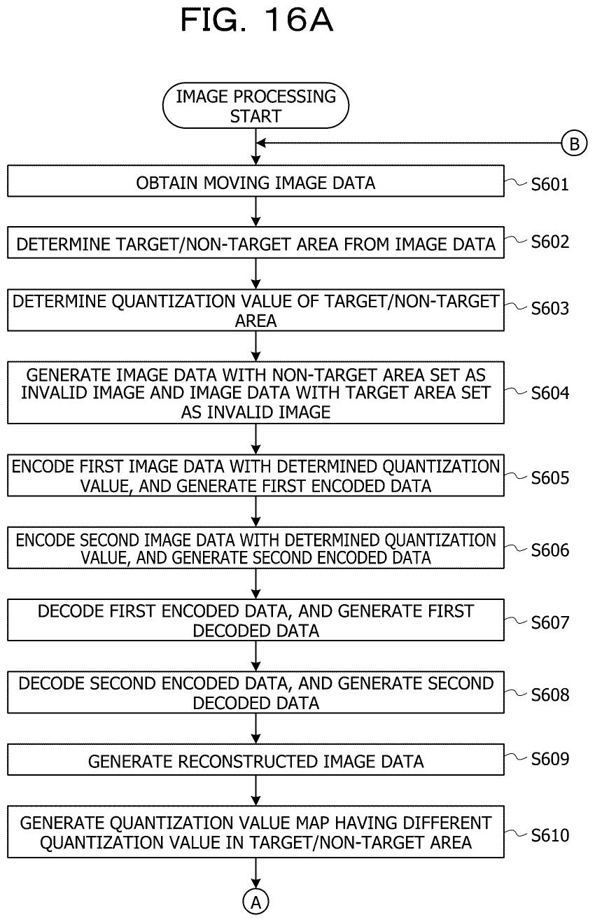

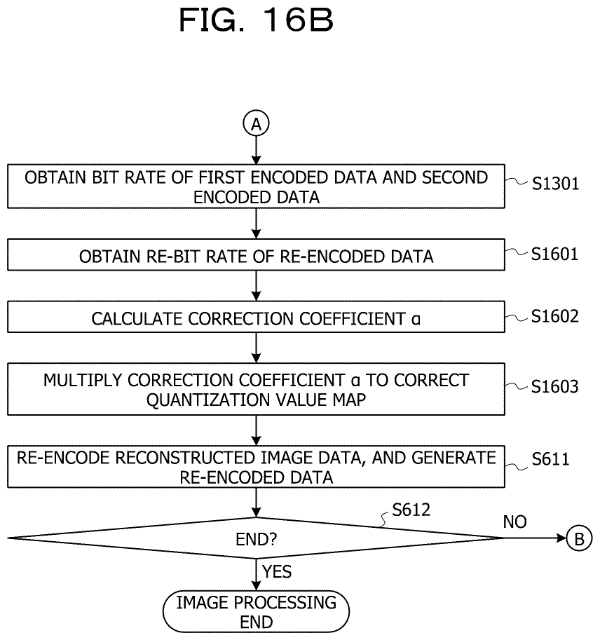

Next, a flow of image processing by the image processing system 100 according to the fifth embodiment will be described. FIG. 16 is a fifth flowchart illustrating the flow of the image processing. Differences from FIG. 13 are steps S1601 to S1603.

In step S1601, the transcode unit 121 of the server device 130 obtains the re-bit rate of the re-encoded data transmitted from the re-encoding unit 450.

In step S1602, the transcode unit 121 of the server device 130 calculates the correction coefficient α based on the bit rates (first and second bit rates) obtained in step S1301 and the re-bit rate obtained in step S1601.

In step S1603, the transcode unit 121 of the server device 130 corrects the quantization value map by multiplying the target area of the quantization value map generated in step S610 by the correction coefficient α calculated in step S1602. As a result, the transcode unit 121 of the server device 130 generates the corrected quantization value map.

As is clear from the descriptions above, in the image processing system 100 according to the fifth embodiment, the quantization value map generation unit corrects the quantization value map, which has been generated based on the information regarding the area and the quantization value, based on the ratio between the first and second bit rates and the re-bit rate.

Thus, according to the image processing system 100 according to the fifth embodiment, the quantization value map may be corrected according to the ratio between the first and second bit rates and the re-bit rate.

As a result, according to the image processing system 100 according to the fifth embodiment, effects similar to those of the first embodiment described above may be exerted, and occurrence of a transmission delay may be avoided.

### Sixth Embodiment

In the first to third and fifth embodiments described above, the case has been described in which the quantization value map is generated based on the information regarding the area and the quantization value, and in the fourth embodiment described above, the case has been described in which the quantization value map is generated based on the bit rate. However, the method of generating the quantization value map is not limited thereto. For example, the quantization value map may be generated based on an attribute of the image data of each frame included in the moving image data captured by the imaging device 110 and an attribute of the corresponding reconstructed image data generated by the reconstruction unit 430. Hereinafter, a sixth embodiment will be described focusing on differences from each of the embodiments described above.

### <Functional Configuration of Hierarchical Encoding Device>

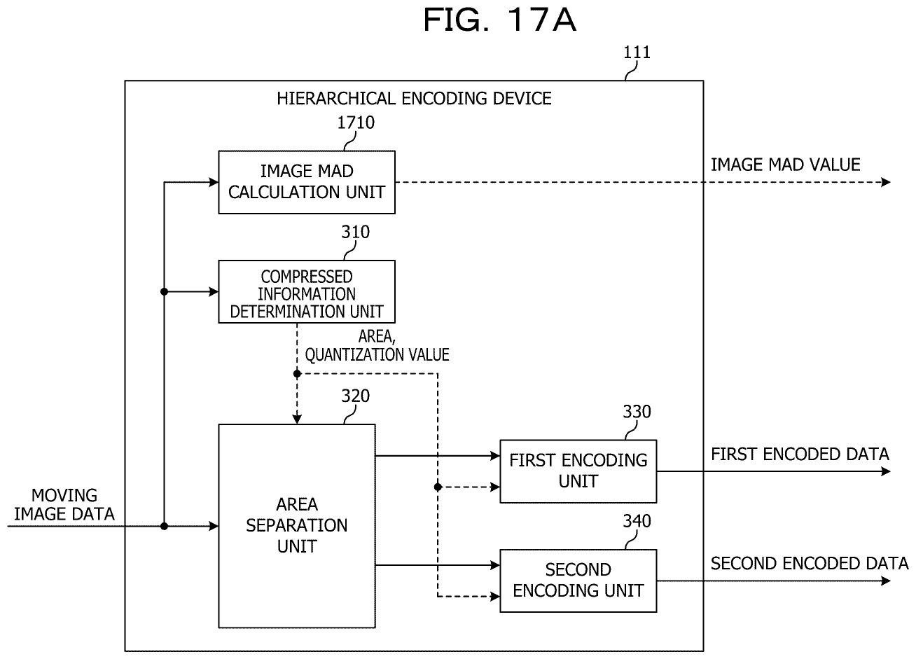

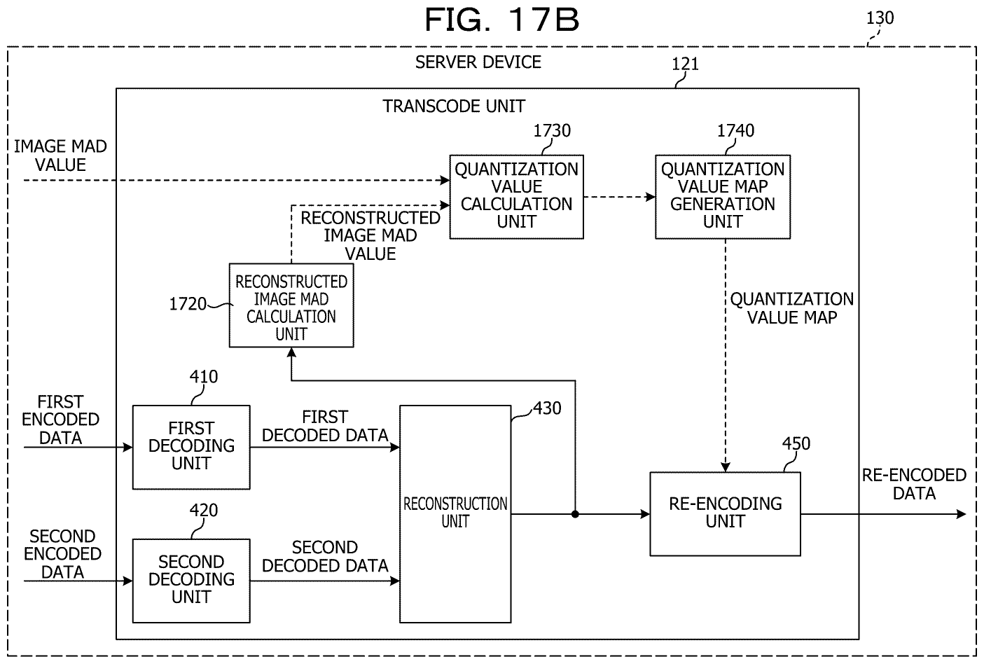

First, a functional configuration of a hierarchical encoding device 111 of an image processing system 100 according to the sixth embodiment will be described with reference to FIG. 17A. FIG. 17A is a third diagram illustrating an exemplary functional configuration of the hierarchical encoding device. A difference from FIG. 3 is that an image mean absolute deviation (MAD) calculation unit 1710 is included.

The image MAD calculation unit 1710 calculates an image mean absolute deviation (MAD) value for each encoding block for image data of each frame included in moving image data. Furthermore, the calculated image MAD value of each encoding block is transmitted to a server device 130. Note that the MAD value refers to variance of pixel values in the image data, and the image MAD calculation unit 1710 calculates the image MAD value of the encoding block based on, for example, the following equation (2).

$$[ Equation 2 ]$$

$$Image MAD value of encoding block = \frac{1}{n} {{\sum }_{i = 1}}^{n} \begin{matrix}( pixel value of pixel i in encoding block - \\ {average of pixel value of each pixel in encoding block )}^{2}\end{matrix} \qquad Equation ( 2 )$$

Note that, in the equation (2) set out above, i represents an identifier for identifying each pixel in the encoding block of the image data, and n represents the number of pixels in the encoding block.

### <Functional Configuration of Transcode Unit>

Next, a functional configuration of a transcode unit 121 of the server device 130 in the image processing system 100 according to the sixth embodiment will be described with reference to FIG. 17B. FIG. 17B is a sixth diagram illustrating an exemplary functional configuration of the transcode unit.

Differences from FIG. 4 are that a reconstructed image MAD calculation unit 1720 and a quantization value calculation unit 1730 are included and that a function of a quantization value map generation unit 1740 is different from that of the quantization value map generation unit 440 illustrated in FIG. 4.

The reconstructed image MAD calculation unit 1720 calculates a reconstructed image MAD value for each encoding block based on reconstructed image data generated by a reconstruction unit 430. Furthermore, it notifies the quantization value calculation unit 1730 of the calculated reconstructed image MAD value of each encoding block. Note that the reconstructed image MAD calculation unit 1720 calculates the reconstructed image MAD value of the encoding block based on, for example, the following equation (3).

$$[ Equation 3 ]$$

$$Reconstructed image MAD value of encoding block = \frac{1}{n} {{\sum }_{j = 1}}^{n} {( \begin{matrix}pixel value of pixel j in encoding block of \\ \begin{matrix}reconstructed image - average of pixel value of each \\ pixel in encoding block of reconstructed image\end{matrix}\end{matrix} )}^{2} \qquad Equation ( 3 )$$

Note that, in the equation (3) set out above, j represents an identifier for identifying each pixel in the encoding block of the reconstructed image data, and n represents the number of pixels in the encoding block.

The quantization value calculation unit 1730 calculates a quantization value of each encoding block based on the image MAD value of each encoding block transmitted from the hierarchical encoding device 111 and the reconstructed image MAD value of each encoding block notified from the reconstructed image MAD calculation unit 1720.

Furthermore, the quantization value calculation unit 1730 notifies the quantization value map generation unit 1740 of the calculated quantization value of each encoding block.

The quantization value map generation unit 1740 generates a quantization value map based on the quantization value of each encoding block transmitted from the quantization value calculation unit 1730, and notifies a re-encoding unit 450.

### Specific Processing Example of Quantization Value Calculation Unit

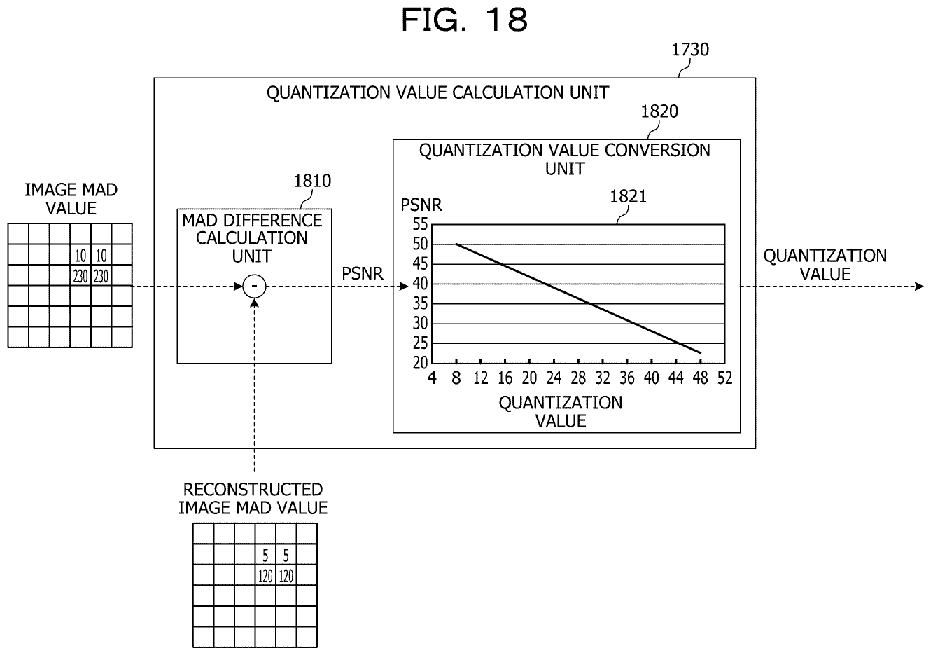

Next, a specific example of the processing of the quantization value calculation unit 1730 will be described. FIG. 18 is a first diagram illustrating a specific example of the processing of the quantization value calculation unit. As illustrated in FIG. 18, the quantization value calculation unit 1730 further includes a MAD difference calculation unit 1810, and calculates a difference between the image MAD value transmitted from the hierarchical encoding device 111 and the reconstructed image MAD value notified from the reconstructed image MAD calculation unit 1720.

Here, the difference between the image MAD value and the reconstructed image MAD value has a conversion relationship with a peak signal-to-noise ratio (PSNR). Therefore, the MAD difference calculation unit 1810 may calculate the PSNR based on the difference between the image MAD value and the reconstructed image MAD value.

Furthermore, as illustrated in FIG. 18, the quantization value calculation unit 1730 further includes a quantization value conversion unit 1820, and calculates a quantization value based on the PSNR calculated by the MAD difference calculation unit 1810.

Here, there is a relationship between the PSNR and the quantization value as illustrated in a graph 1821. Therefore, the quantization value conversion unit 1820 may calculate and output the quantization value from the PSNR by referring to the graph 1821.

Note that the quantization value calculation unit 1730 outputs the quantization value for each encoding block by performing the processing described above for each encoding block.

### <Image Processing Flow in Image Processing System>

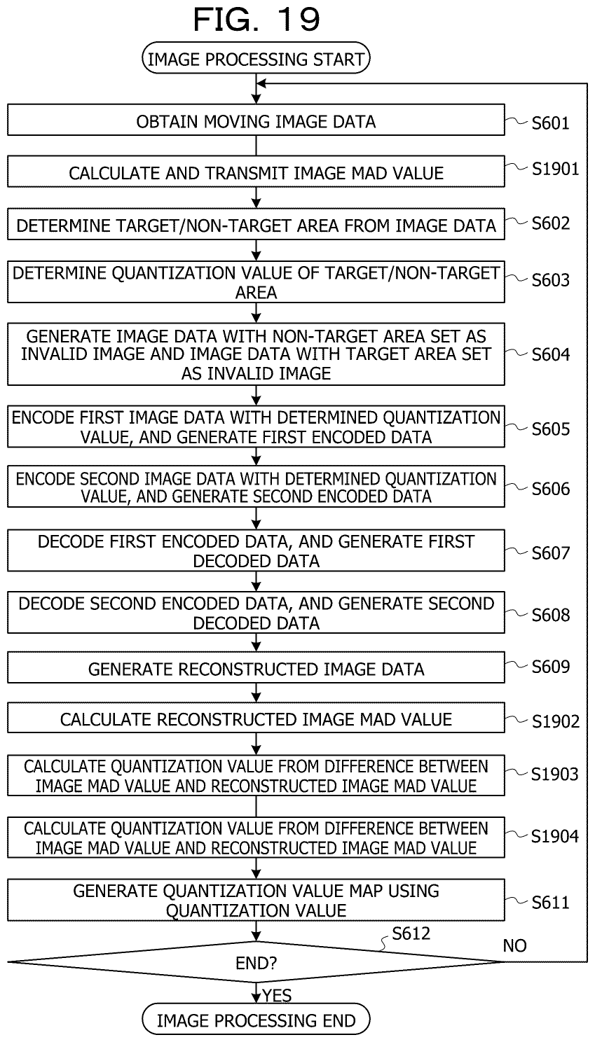

Next, a flow of image processing by the image processing system 100 according to the sixth embodiment will be described. FIG. 19 is a sixth flowchart illustrating the flow of the image processing. Differences from FIG. 6 are steps S1901 and S1902 to S1904.

In step S1901, the hierarchical encoding device 111 calculates an image MAD value for each encoding block with respect to the image data of each frame included in the moving image data, and transmits the image MAD value to the server device 130.

In step S1902, the transcode unit 121 of the server device 130 calculates a reconstructed image MAD value for each encoding block with respect to the reconstructed image data.

In step S1903, the transcode unit 121 of the server device 130 calculates a difference between the image MAD value and the reconstructed image MAD value for each encoding block, and calculates a quantization value from the PSNR value corresponding to the difference.

In step S1904, the transcode unit 121 of the server device 130 generates a quantization value map using the quantization value for each encoding block.

As is clear from the descriptions above, the image processing system 100 according to the sixth embodiment calculates the quantization value for each encoding block based on the difference between the image MAD value and the reconstructed image MAD value, and generates the quantization value map.

Thus, according to the image processing system 100 according to the sixth embodiment, the quantization value map may be generated based on an attribute of image data captured by an imaging device 110 and an attribute of the reconstructed image data generated by the reconstruction unit 430.

As a result, according to the image processing system 100 according to the sixth embodiment, effects similar to those of the first embodiment described above may be exerted.

### Seventh Embodiment

In the sixth embodiment described above, the case has been described in which the PSNR is calculated based on the attribute of the image data and the attribute of the reconstructed image data and the quantization value is calculated from the calculated PSNR to generate the quantization value map. However, the generation method of generating the quantization value map based on the attribute of the image data and the attribute of the reconstructed image data is not limited to the generation method described in the sixth embodiment described above. Furthermore, in the sixth embodiment described above, the case has been described in which the generated quantization value map is applied to all pieces of the reconstructed image data. However, the application destination of the generated quantization value map is not limited to the application destination (all pieces of the reconstructed image data) described in the sixth embodiment described above. Hereinafter, a seventh embodiment will be described focusing on differences from the sixth embodiment described above.

### Specific Example of Processing of Quantization Value Calculation Unit and Processing of Quantization Value Map Generation Unit

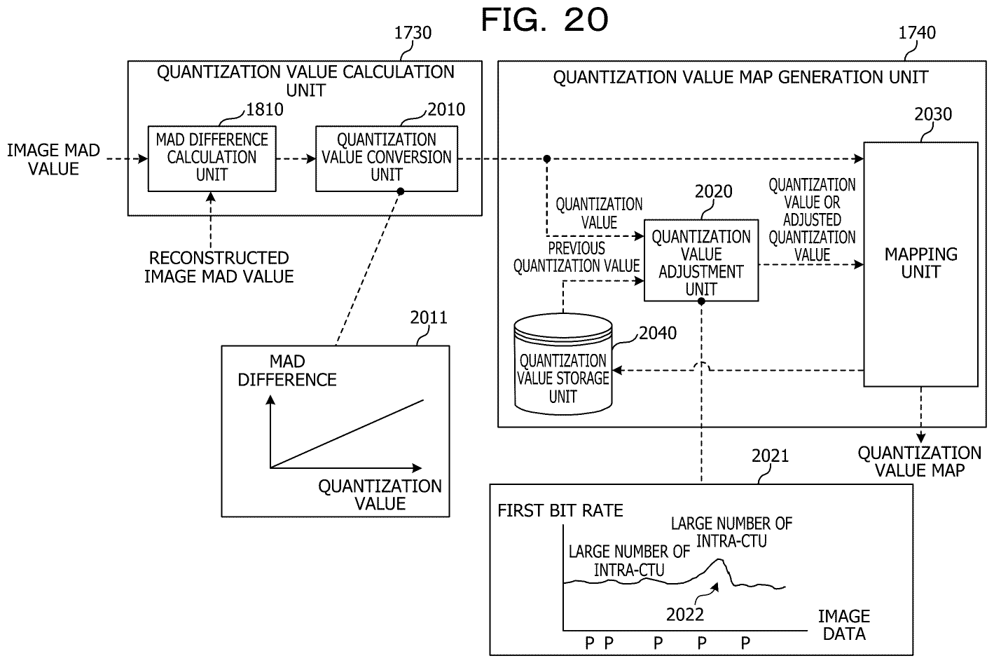

First, specific examples of processing of a quantization value calculation unit 1730 and processing of a quantization value map generation unit 1740 according to the seventh embodiment will be described. FIG. 20 is a diagram illustrating a specific example of the processing of the quantization value calculation unit and the quantization value map generation unit. As illustrated in FIG. 20, the quantization value calculation unit 1730 further includes a MAD difference calculation unit 1810 and a quantization value conversion unit 2010. Of those units, the MAD difference calculation unit 1810 is the same as the MAD difference calculation unit 1810 described in the sixth embodiment described above with reference to FIG. 18, and thus descriptions thereof will be omitted here.

The quantization value conversion unit 2010 directly calculates a quantization value for each encoding block based on a difference between an image MAD value and a reconstructed image MAD value calculated by the MAD difference calculation unit 1810. Note that, in the sixth embodiment described above, the PSNR is calculated based on the difference between the image MAD value and the reconstructed image MAD value, and the quantization value is calculated from the calculated PSNR.

On the other hand, in the seventh embodiment, a relationship between the difference between the image MAD value and the reconstructed image MAD value and the quantization value is obtained in advance (see reference sign 2011), and the quantization value for each encoding block is directly calculated from the difference between the image MAD value and the reconstructed image MAD value based on the relationship.

Furthermore, the quantization value conversion unit 2010 notifies the quantization value map generation unit 1740 of the calculated quantization value for each encoding block.

As illustrated in FIG. 20, the quantization value map generation unit 1740 further includes a quantization value adjustment unit 2020 and a mapping unit 2030, and the quantization value for each encoding block notified from the quantization value conversion unit 2010 is input to the quantization value adjustment unit 2020 and the mapping unit 2030.

Here, when the corresponding image data is an I-picture, the quantization value map generation unit 1740 generates a quantization value map using the quantization value for each encoding block notified from the quantization value conversion unit 2010.

Furthermore, when the corresponding image data is a P-picture, the quantization value map generation unit 1740 generates a quantization value map basically using the quantization value applied to the previous P-picture. However, when the number of encoding blocks to which an intra prediction mode is applied at the time of encoding is large, the quantization value map generation unit 1740 generates a quantization value map using:
the quantization value for each encoding block notified from the quantization value conversion unit 2010; and
the quantization value applied to the previous P-picture.

This will be specifically described with reference to FIG. 20. When the corresponding image data is an I-picture, the mapping unit 2030 generates a quantization value map using the quantization value for each encoding block notified from the quantization value conversion unit 2010. Furthermore, when the image data is a P-picture, the mapping unit 2030 generates a quantization value map using the quantization value for each encoding block notified from the quantization value adjustment unit 2020. Moreover, the mapping unit 2030 notifies a re-encoding unit 450 of the generated quantization value map, and stores it in a quantization value storage unit 2040.

When the image data is a P-picture, the quantization value adjustment unit 2020 refers to the quantization value storage unit 2040 to read the quantization value applied to the previous P-picture from the quantization value storage unit 2040. Furthermore, the quantization value adjustment unit 2020 notifies the mapping unit 2030 of the read quantization value.

However, when the image data is a P-picture and the number of encoding blocks to which the intra prediction mode is applied at the time of encoding is large, the quantization value adjustment unit 2020 adjusts the quantization value using:
the quantization value for each encoding block notified from the quantization value conversion unit 2010; and
the quantization value applied to the previous P-picture,

and notifies the mapping unit 2030 of the adjusted quantization value.

In FIG. 20, a reference sign 2021 denotes a graph illustrating a relationship between image data and a first bit rate (bit rate of first encoded data). Among the pieces of image data of individual frames included in moving image data, image data having a high first bit rate in the graph denoted by the reference sign 2021 is image data having a large number of encoding blocks to which the intra prediction mode is applied. Note that examples of the encoding block to which the intra prediction mode is applied include an encoding block of a moving area, an encoding block of a boundary region between a target area and a non-target area, and the like.

In the case of the example of the reference sign 2021, the quantization value adjustment unit 2020 adjusts the quantization value in the case of image data of a P-picture indicated by a reference sign 2022.

### <Image Processing Flow in Image Processing System>

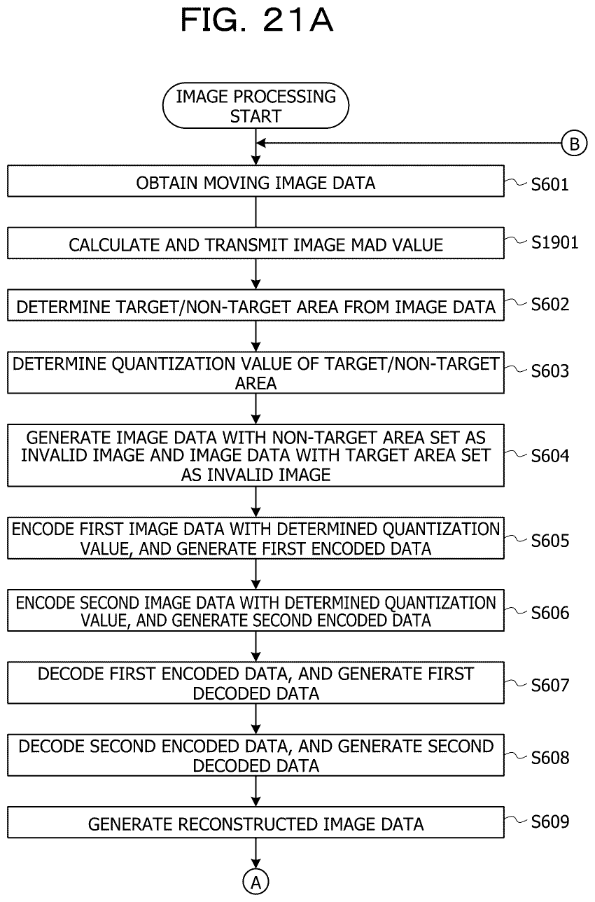

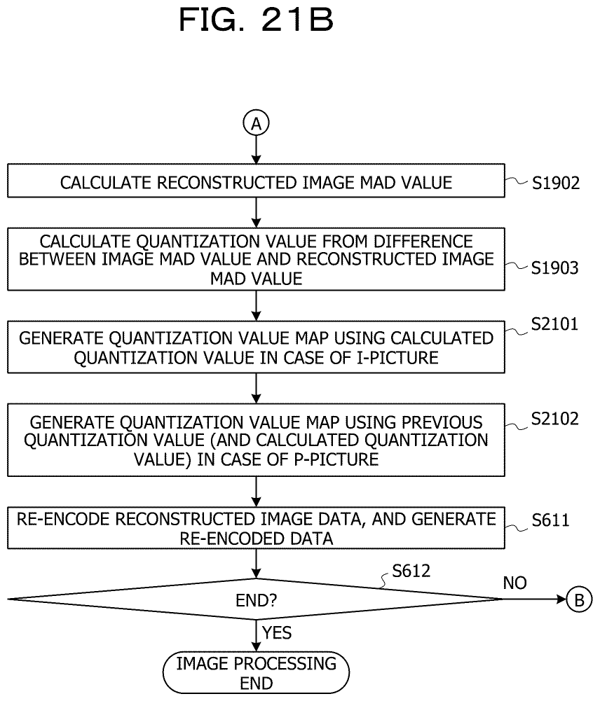

Next, a flow of image processing by the image processing system 100 according to the seventh embodiment will be described. FIG. 21 is a seventh flowchart illustrating the flow of the image processing. Differences from FIG. 19 are steps S2101 and S2102.

In step S2101, when the image data is an I-picture, a transcode unit 121 of a server device 130 generates a quantization value map using the quantization value for each encoding block calculated in step S1903.

In step S2102, when the image data is a P-picture, the transcode unit 121 of the server device 130 generates a quantization value map using the quantization value applied to the previous P-picture. However, when the number of encoding blocks to which the intra prediction mode is applied at the time of encoding is large, the transcode unit 121 of the server device 130 adjusts the quantization value applied to the previous P-picture using the quantization value calculated this time (step S1903). Then, the transcode unit 121 of the server device 130 generates a quantization value map using the adjusted quantization value.

As is clear from the descriptions above, at a time of generating the quantization value map based on an attribute of the image data and an attribute of the reconstructed image data, the image processing system 100 according to the seventh embodiment performs processing of:
directly calculating the quantization value from the difference between the two;
generating different quantization value maps for the I-picture and the P-picture; and
generating different quantization value maps depending on the prediction mode at the time of encoding for the P-picture.

Thus, according to the image processing system 100 according to the seventh embodiment, the quantization value map suitable for the content of the encoding processing may be generated.

As a result, according to the image processing system 100 according to the seventh embodiment, effects similar to those of the first embodiment described above may be exerted, and an appropriate quantization value map may be generated.

### Eighth Embodiment

In the sixth and seventh embodiments described above, the case has been described in which the quantization value is determined based on the attribute of the image data and the attribute of the reconstructed image data to generate the quantization value map. However, the method of generating the quantization value map is not limited to this, and for example, the quantization value may be determined based on the attribute of the reconstructed image data such that the bit rate (re-bit rate) of the reconstructed image data approaches a target bit rate to generate the quantization value map. Hereinafter, an eighth embodiment will be described focusing on differences from the sixth and seventh embodiments described above.

### <Functional Configuration of Transcode Unit>

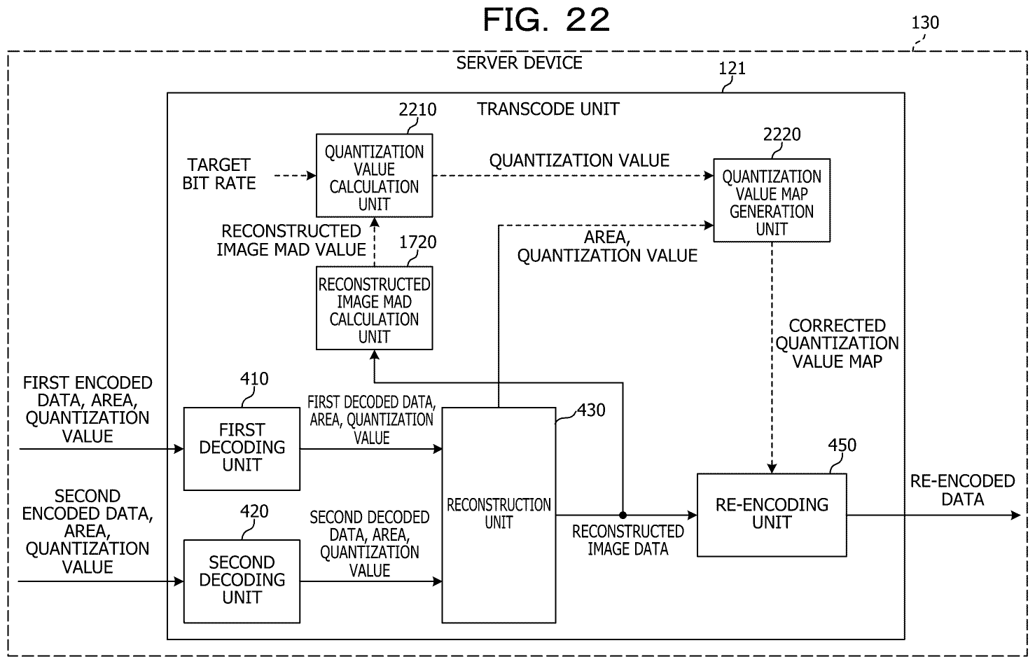

First, a functional configuration of a transcode unit 121 of a server device 130 in an image processing system 100 according to the eighth embodiment will be described with reference to FIG. 22. FIG. 22 is a seventh diagram illustrating an exemplary functional configuration of the transcode unit.

A difference from FIG. 17B is that functions of a quantization value calculation unit 2210 and a quantization value map generation unit 2220 are different from the functions of the quantization value calculation unit 1730 and the quantization value map generation unit 1740 illustrated in FIG. 17B.

The quantization value calculation unit 2210 determines a quantization value based on a reconstructed image MAD value notified from a reconstructed image MAD calculation unit 1720. Furthermore, the quantization value calculation unit 2210 notifies the quantization value map generation unit 2220 of the determined quantization value.

Note that the quantization value calculation unit 2210 may determine quantization values of all encoding blocks, or may determine a quantization value of an encoding block corresponding to a target area. FIG. 22 illustrates a case where the quantization value calculation unit 2210 determines the quantization value of the encoding block corresponding to the target area. For example, the quantization value calculation unit 2210 determines the quantization value of the encoding block corresponding to the target area such that a re-bit rate of re-encoded data predicted based on the reconstructed image MAD value becomes a target bit rate.

Furthermore, the quantization value calculation unit 2210 notifies the quantization value map generation unit 2220 of the determined quantization value.

The quantization value map generation unit 2220 generates a quantization value map based on information regarding an area and a quantization value notified from a reconstruction unit 430. Furthermore, the quantization value map generation unit 2220 corrects the quantization value of the encoding block corresponding to the target area in the generated quantization value map with the quantization value notified from the quantization value calculation unit 2210, and notifies a re-encoding unit 450 of the corrected quantization value map.

### Specific Processing Example of Quantization Value Calculation Unit

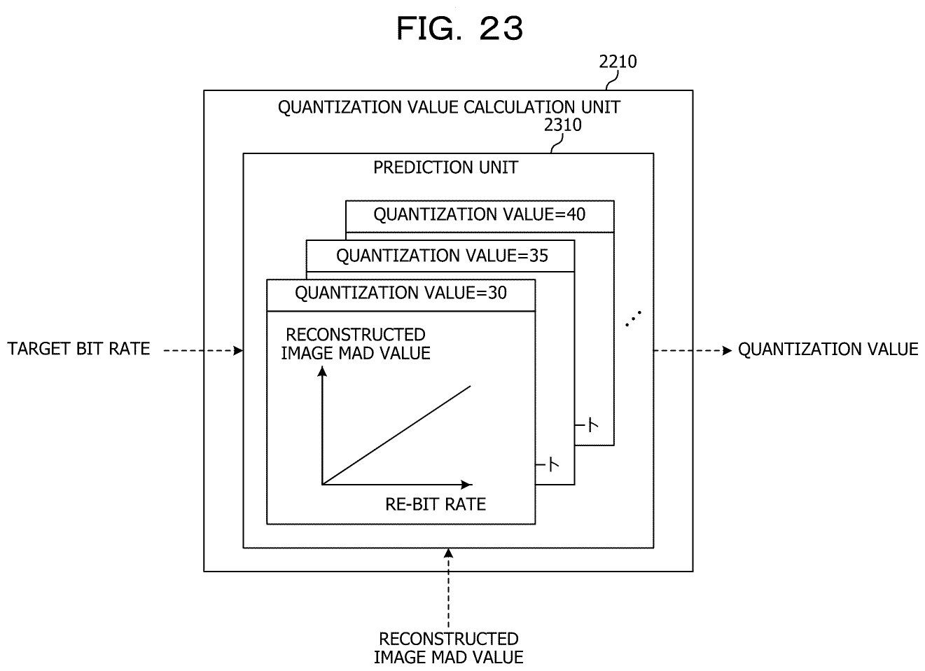

Next, a specific example of the processing of the quantization value calculation unit 2210 will be described. FIG. 23 is a second diagram illustrating a specific example of the processing of the quantization value calculation unit. As illustrated in FIG. 23, the quantization value calculation unit 2210 includes a prediction unit 2310, and obtains the reconstructed image MAD value from the reconstructed image MAD calculation unit 1720.

The prediction unit 2310 retains a relationship between the reconstructed image MAD value and the re-bit rate for each quantization value in advance, and predicts the re-bit rate of the re-encoded data when each quantization value is used from the obtained reconstructed image MAD value based on the relationship. Furthermore, the prediction unit 2310 determines the quantization value at which the predicted re-bit rate becomes the target bit rate, and notifies the quantization value map generation unit 2220 of the determined quantization value as the quantization value of the encoding block corresponding to the target area.

### <Image Processing Flow in Image Processing System>

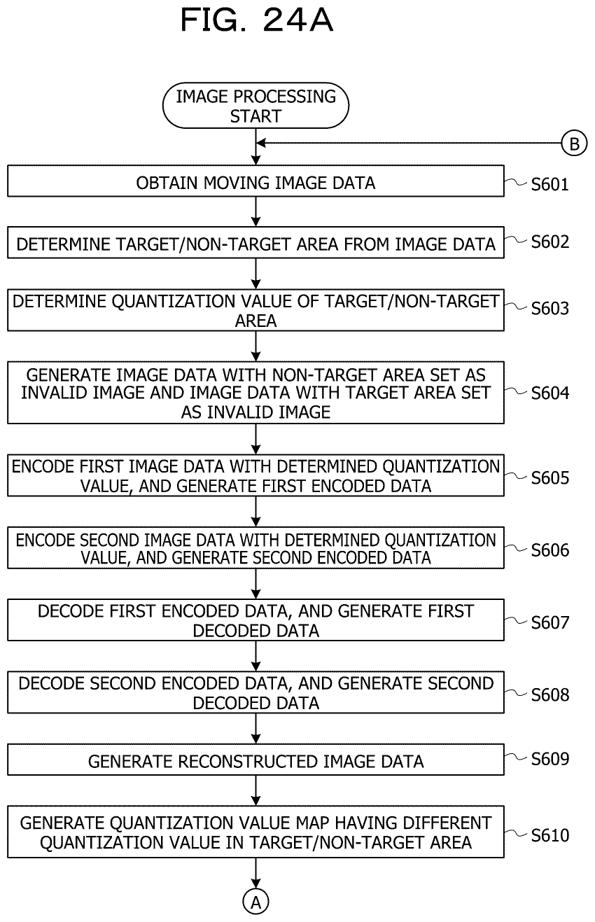

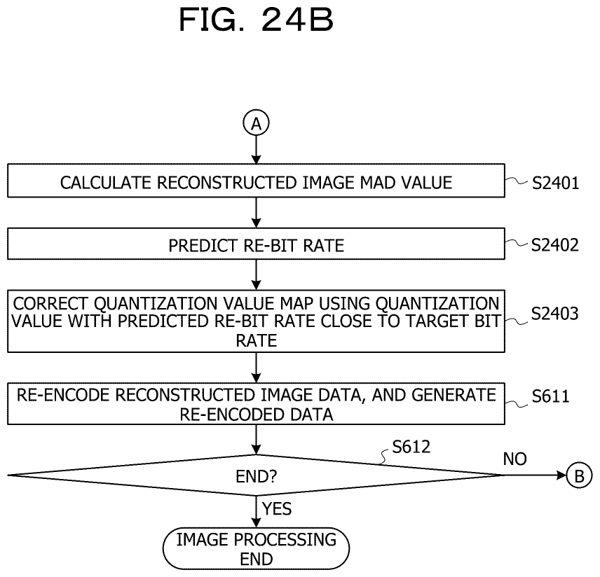

Next, a flow of image processing by the image processing system 100 according to the eighth embodiment will be described. FIG. 24 is an eighth flowchart illustrating the flow of the image processing. Differences from FIG. 6 are steps S2401 to S2403.

In step S2401, the transcode unit 121 of the server device 130 calculates a reconstructed image MAD value for each encoding block corresponding to the target area in the reconstructed image data.

In step S2402, the transcode unit 121 of the server device 130 predicts the re-bit rate of the re-encoded data when encoding is carried out using each quantization value based on the calculated reconstructed image MAD value.

In step S2403, the transcode unit 121 of the server device 130 determines the quantization value corresponding to the re-bit rate closest to the target bit rate among the predicted re-bit rates. Furthermore, the transcode unit 121 of the server device 130 corrects the quantization value of the encoding block corresponding to the target area in the quantization value map generated in step S610 using the determined quantization value, and generates a corrected quantization value map.

As is clear from the descriptions above, the image processing system 100 according to the eighth embodiment corrects the quantization value map such that the re-bit rate of the re-encoded data predicted based on the reconstructed image MAD value approaches the target bit rate.

Thus, according to the image processing system 100 according to the eighth embodiment, the re-bit rate of the re-encoded data may be controlled to the target bit rate.

As a result, according to the image processing system 100 according to the eighth embodiment, effects similar to those of the first embodiment described above may be exerted, and occurrence of a transmission delay may be avoided.

### Ninth Embodiment

In the first embodiment described above, the case has been described in which the quantization value map generation unit generates the quantization value map based on the information regarding the area and the quantization value. However, the method of generating the quantization value map is not limited to this, and for example, the quantization value map may be generated using the minimum value of the information regarding the area and the quantization value calculated for the image data of each frame included in the moving image data. Hereinafter, a ninth embodiment will be described focusing on differences from the first embodiment described above.

### <Functional Configuration of Transcode Unit>

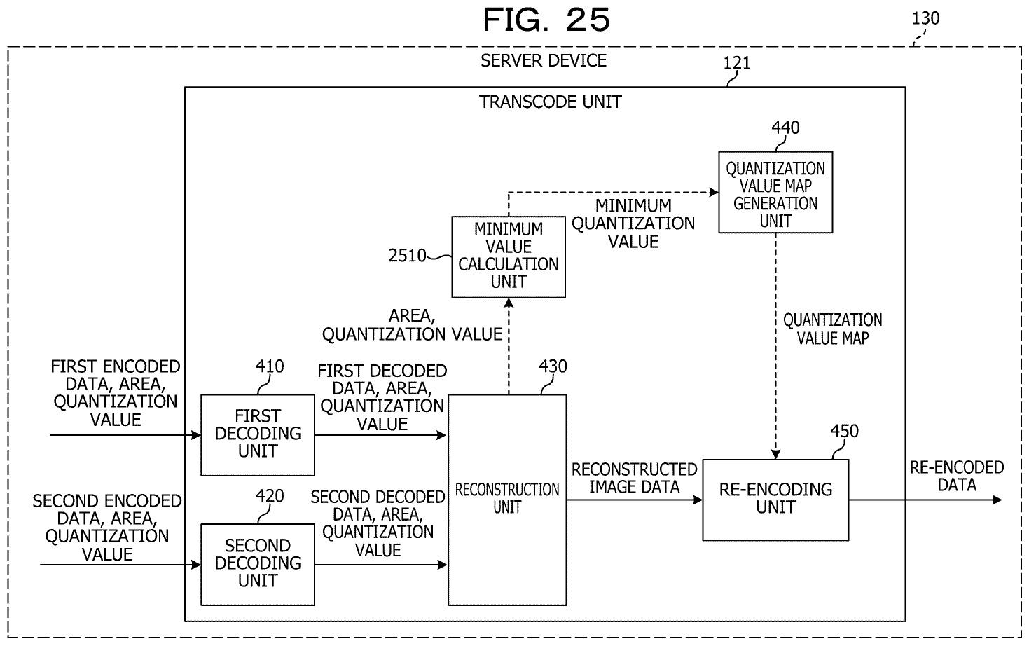

FIG. 25 is an eighth diagram illustrating an exemplary functional configuration of a transcode unit, and is an exemplary functional configuration in a case of generating a quantization value map using the minimum value of information regarding an area and a quantization value.

A difference from FIG. 4 is that a minimum value calculation unit 2510 is included. The minimum value calculation unit 2510 performs processing of:
calculating the minimum value of image data of a predetermined number of frames with respect to the information regarding the area and the quantization value (target area and limit quantization value) notified from a first decoding unit 410 to calculate the minimum quantization value of a target area; and
calculating the minimum value of the image data of the predetermined number of frames with respect to the information regarding the area and the quantization value (non-target area and predetermined quantization value) notified from a second decoding unit 420 to calculate the minimum quantization value of a non-target area.

Furthermore, the minimum value calculation unit 2510 notifies a quantization value map generation unit 440 of the calculated minimum quantization value.

### <Image Processing Flow in Image Processing System>

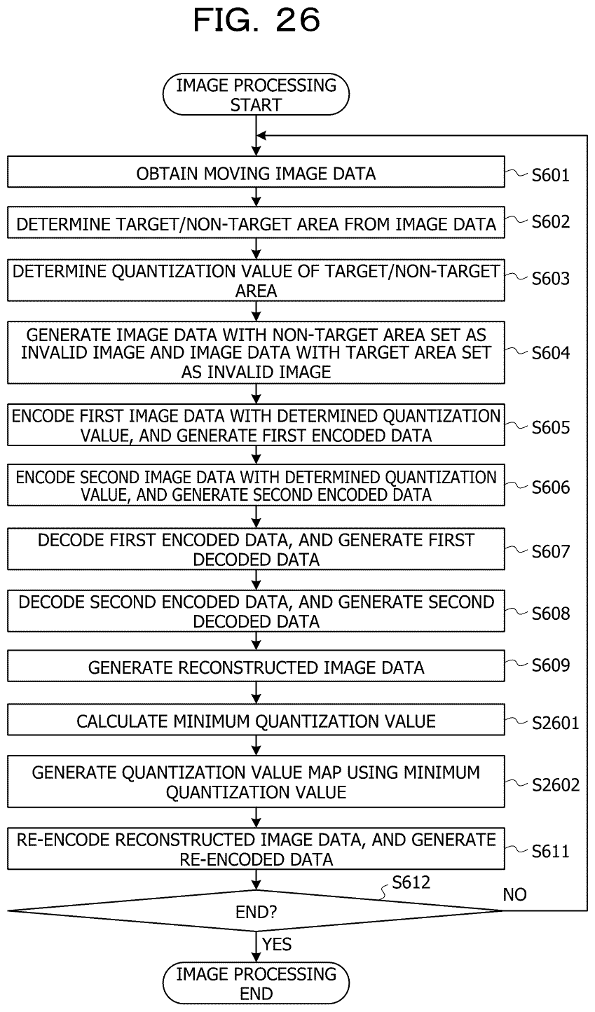

Next, a flow of image processing by an image processing system 100 according to the ninth embodiment will be described. FIG. 26 is a ninth flowchart illustrating the flow of the image processing. Differences from FIG. 6 are steps S2601 and S2602.

In step S2601, a transcode unit 121 of a server device 130 calculates the minimum value of the information regarding the area and the quantization value, thereby calculating the minimum quantization value of the target area and the non-target area.

In step S2602, the transcode unit 121 of the server device 130 generates a quantization value map using the minimum quantization value.

As described above, the information regarding the area and the quantization value determined when a hierarchical encoding device 111 performs encoding processing is effectively used when a re-encoding unit 450 generates re-encoded data, whereby appropriate re-encoded data may be generated.

Note that the method of effectively using the information regarding the area and the quantization value determined when the hierarchical encoding device 111 performs the encoding processing is not limited to the description above. For example, when the transcode unit 121 is enabled to directly obtain the quantization value map used when each of a first encoding unit 330 and a second encoding unit 340 encodes the image data, the re-encoded data may be generated using the obtained quantization value map.

Furthermore, when the encoding scheme of the first encoding unit 330 and the second encoding unit 340 is different from the encoding scheme of the re-encoding unit 450, the re-encoded data may be generated after predetermined correction is made on the obtained quantization value map.

Note that, while the minimum value of the information regarding the area and the quantization value calculated for the image data of each frame included in the moving image data is used in the descriptions above, an average value may be used. Furthermore, among the pieces of information regarding the area and the quantization value in the target area, information corresponding to an outlier may be excluded at the time of calculating the minimum quantization value or the average quantization value. Alternatively, among the pieces of information regarding the area and the quantization value in the non-target area, information corresponding to an outlier may be excluded at the time of calculating the minimum quantization value or the average quantization value.

### Tenth Embodiment

In the fifth embodiment described above, the case has been described in which the correction coefficient α is calculated based on the bit rates of the first encoded data and the second encoded data and the bit rate of the re-encoded data, but the method of calculating the correction coefficient α is not limited to this. For example, the correction coefficient α may be calculated using a PSNR calculated for re-decoded data. Hereinafter, a tenth embodiment will be described focusing on differences from each of the embodiments described above.

### <Functional Configuration of Transcode Unit>

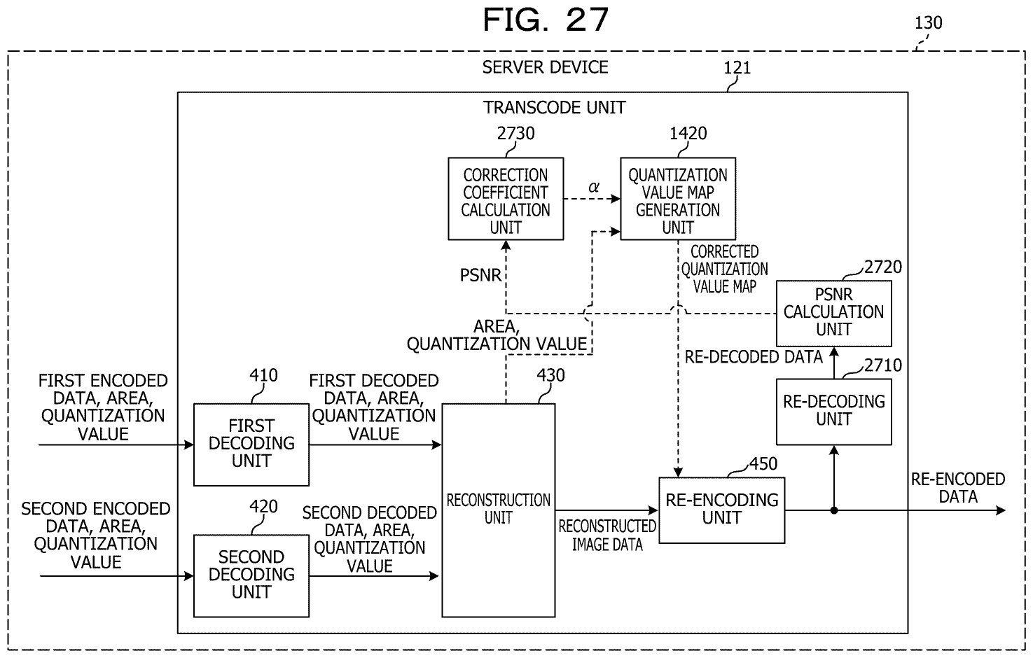

First, a functional configuration of a transcode unit 121 of a server device 130 in an image processing system 100 according to the tenth embodiment will be described with reference to FIG. 27. FIG. 27 is a ninth diagram illustrating an exemplary functional configuration of the transcode unit. Differences from FIG. 14 are that a re-decoding unit 2710 and a PSNR calculation unit 2720 are included and a function of a correction coefficient calculation unit 2730 is different from the function of the correction coefficient calculation unit 1410 illustrated in FIG. 14.

The re-decoding unit 2710 re-decodes re-encoded data generated by a re-encoding unit 450, and generates re-decoded data. The re-decoding unit 2710 notifies the PSNR calculation unit 2720 of the generated re-decoded data.

The PSNR calculation unit 2720 calculates a PSNR of the re-decoded data notified from the re-decoding unit 2710, and notifies the correction coefficient calculation unit 2730 of the calculated PSNR.

The correction coefficient calculation unit 2730 calculates a correction coefficient α based on the PSNR calculated for the re-decoded data corresponding to the previous image data and the PSNR calculated for the re-decoded data corresponding to the current image data. Furthermore, the correction coefficient calculation unit 2730 notifies a quantization value map generation unit 1420 of the calculated correction coefficient α.

### <Relationship Between PSNR and Quantization Value of Quantization Value Map>

Here, a relationship between the PSNR and a quantization value of a quantization value map will be briefly described. Reconstructed image data re-encoded by the re-encoding unit 450 using the quantization value map is generated based on first decoded data and second decoded data, and a part of information is lost when a first encoding unit 330 and a second encoding unit 340 carry out encoding.

Meanwhile, even if the quantization value of the quantization value map is made smaller when the re-encoding unit 450 re-encodes the reconstructed image data, the part of information that has already been lost is not restored.

Therefore, when the quantization value of the quantization value map is decreased at the time of re-encoding the reconstructed image data, there is a quantization value at which image quality of the re-decoded data is not further improved (e.g., quantization value at which the PSNR is not further improved).

Furthermore, even if the quantization value of the quantization value map is overly decreased, the data volume of the re-encoded data does not increase beyond measure. In addition, when the quantization value of the quantization value map is overly decreased, encoding noise added when the first encoding unit 330 and the second encoding unit 340 carry out the encoding is reproduced, which may deteriorate the image quality conversely.

For such a reason, it is preferable to correct the quantization value map such that the quantization value does not become smaller than the quantization value at which the PSNR is not further improved at the time of correcting the quantization value map.

### Specific Processing Example of Correction Coefficient Calculation Unit

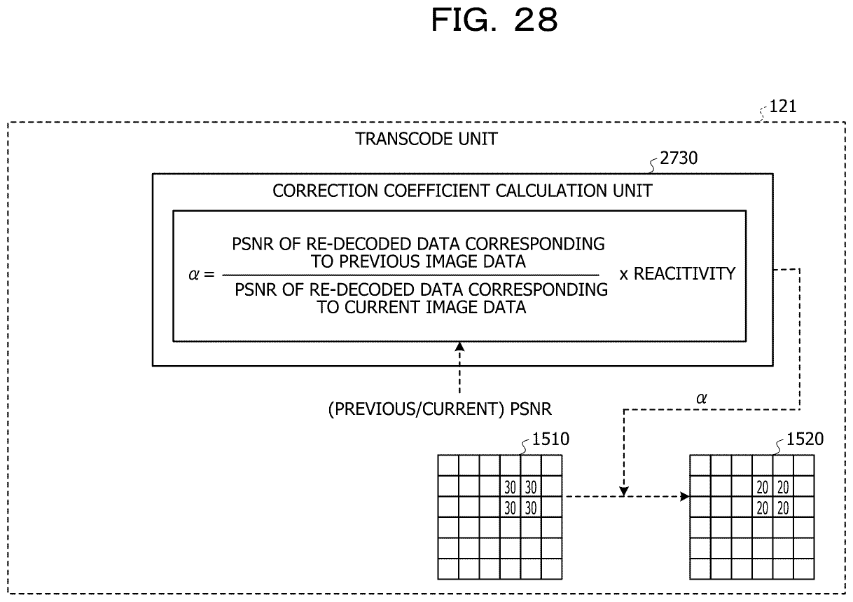

Next, a specific example of the processing of the correction coefficient calculation unit 2730 in consideration of the above-described relationship between the PSNR and the quantization value of the quantization value map will be described. FIG. 28 is a second diagram illustrating a specific example of the processing of the correction coefficient calculation unit. As illustrated in the example of FIG. 28, the correction coefficient calculation unit 2730 calculates the correction coefficient α based on the following equation (4).

$$[ Equation 4 ]$$

$$Correction coefficient a = \frac{\begin{matrix}PSNR of re - decoded data \\ corresponding to previous image data\end{matrix}}{\begin{matrix}PSNR of re - decoded data \\ corresponding to current image data\end{matrix}} \times reactivity \qquad Equation ( 4 )$$

According to the equation (4) set out above, when the PSNR of the re-decoded data corresponding to the current image data is better than the PSNR of the re-decoded data corresponding to the previous image data, the correction coefficient α of smaller than 1 is calculated, and thus the quantization value of the corrected quantization value map is smaller than that before the correction.

On the other hand, when the PSNR of the re-decoded data corresponding to the previous image data is better than the PSNR of the re-decoded data corresponding to the current image data, the correction coefficient α of equal to or larger than 1 is calculated, and thus the quantization value of the corrected quantization value map is larger than that before the correction.

Note that, in the equation (4) set out above, the reactivity is a parameter for gradually reflecting the ratio between the PSNR of the re-decoded data corresponding to the previous image data and the PSNR of the re-decoded data corresponding to the current image data without directly reflecting the ratio in the quantization value.

As illustrated in FIG. 28, the correction coefficient α calculated by the correction coefficient calculation unit 2730 is multiplied to a quantization value map 1510 generated by the quantization value map generation unit 1420, and the quantization value map 1510 is corrected, thereby generating a corrected quantization value map 1520.

### <Image Processing Flow in Image Processing System>

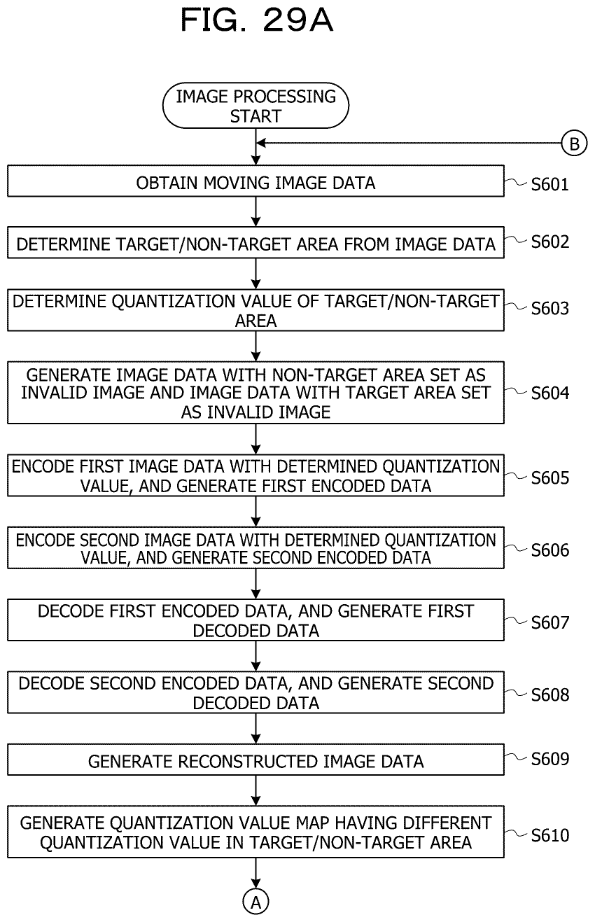

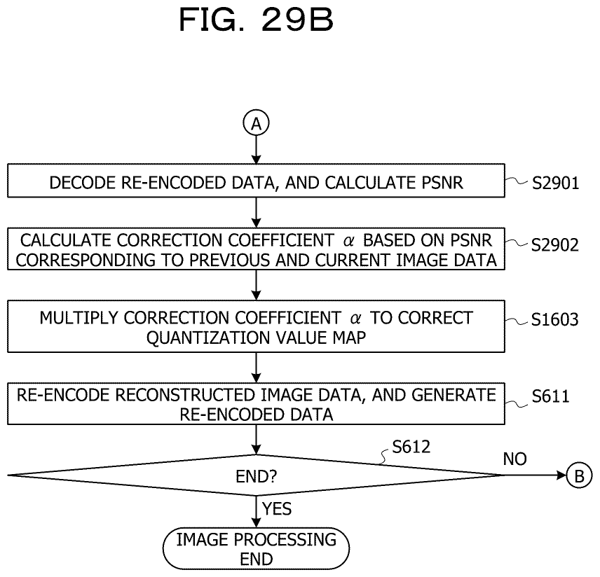

Next, a flow of image processing by the image processing system 100 according to the tenth embodiment will be described. FIG. 29 is a tenth flowchart illustrating the flow of the image processing. Differences from FIG. 16 are steps S2901 and S2902.

In step S2901, the transcode unit 121 of the server device 130 decodes the re-encoded data to calculate the PSNR.

In step S2902, the transcode unit 121 of the server device 130 calculates the correction coefficient α using the PSNR calculated for the re-decoded data corresponding to the previous image data and the PSNR calculated for the re-decoded data corresponding to the current image data.

As is clear from the descriptions above, in the image processing system 100 according to the tenth embodiment, the quantization value map generation unit corrects the quantization value map, which has been generated based on the information regarding the area and the quantization value, based on the PSNR of the re-decoded data corresponding to the previous and current image data.

Thus, according to the image processing system 100 according to the tenth embodiment, the quantization value map may be appropriately corrected based on a change in the PSNR with respect to a change in the quantization value.

As a result, according to the image processing system 100 according to the tenth embodiment, effects similar to those of the first embodiment described above may be exerted, and an appropriate quantization value map may be generated.

### 11th Embodiment

While the case has been described in which the correction coefficient α is calculated using the PSNR calculated for the re-decoded data in the tenth embodiment described above, the method of calculating the correction coefficient α is not limited to this. For example, the correction coefficient α may be calculated using a recognition rate calculated for the re-decoded data. Hereinafter, an 11th embodiment will be described focusing on differences from the tenth embodiment described above.

### <Functional Configuration of Transcode Unit>

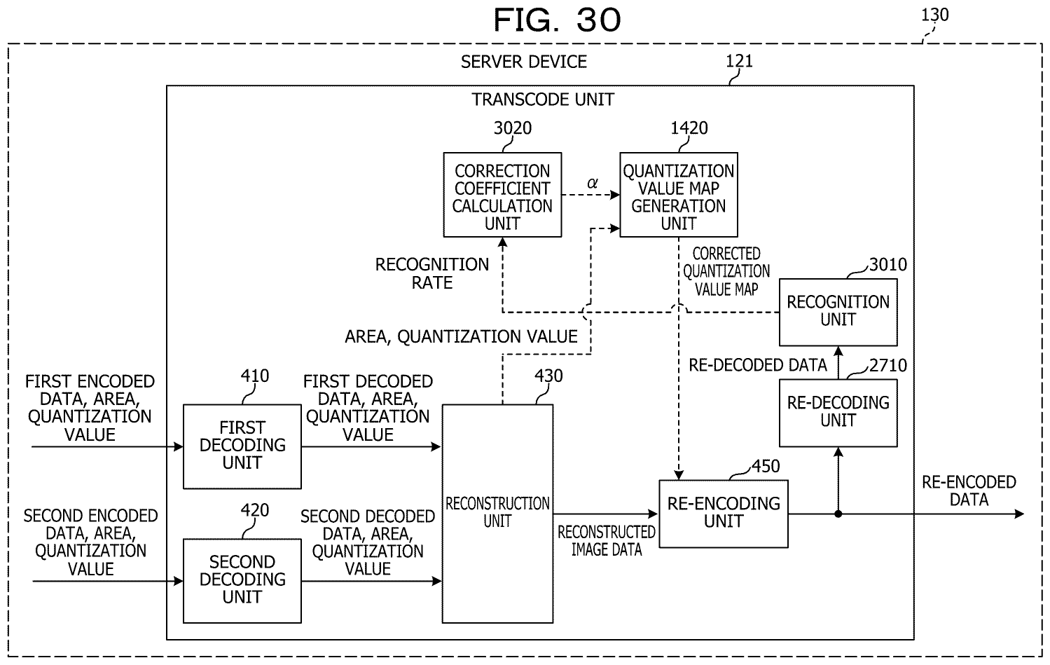

First, a functional configuration of a transcode unit 121 of a server device 130 in an image processing system 100 according to the 11th embodiment will be described with reference to FIG. 30. FIG. 30 is a tenth diagram illustrating an exemplary functional configuration of the transcode unit. Differences from FIG. 27 are that a recognition unit 3010 is included instead of the PSNR calculation unit 2720 and a function of a correction coefficient calculation unit 3020 is different from the function of the correction coefficient calculation unit 2730 illustrated in FIG. 27.

The recognition unit 3010 executes recognition processing for re-decoded data notified from a re-decoding unit 2710 to calculate a recognition rate, and notifies the correction coefficient calculation unit 3020 of the calculated recognition rate.

The correction coefficient calculation unit 3020 calculates a correction coefficient α based on the recognition rate calculated for the re-decoded data corresponding to the previous image data and the recognition rate calculated for the re-decoded data corresponding to the current image data. Furthermore, the correction coefficient calculation unit 3020 notifies a quantization value map generation unit 1420 of the calculated correction coefficient α.

As a result, a quantization value map may be corrected such that the quantization value map is not generated with a quantization value smaller than the quantization value at which the recognition rate is not further improved.

### Specific Processing Example of Correction Coefficient Calculation Unit

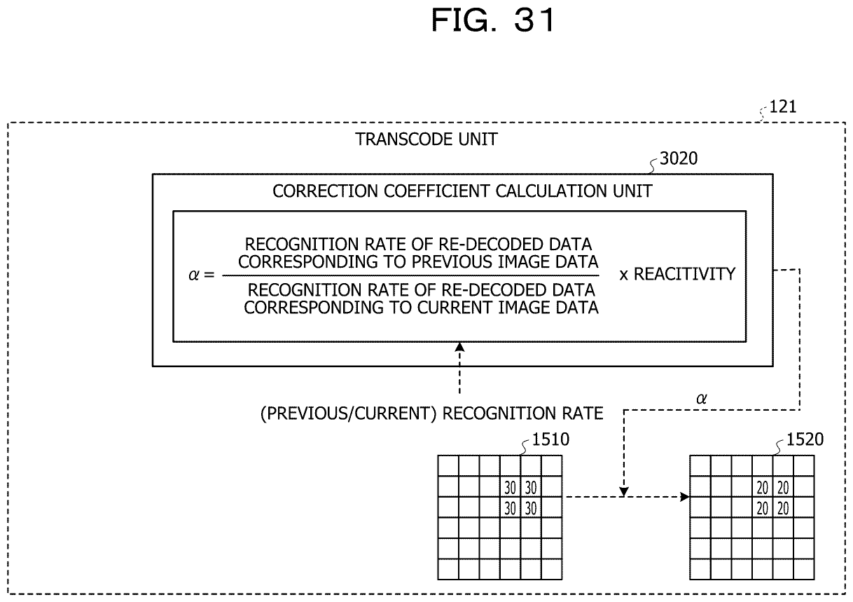

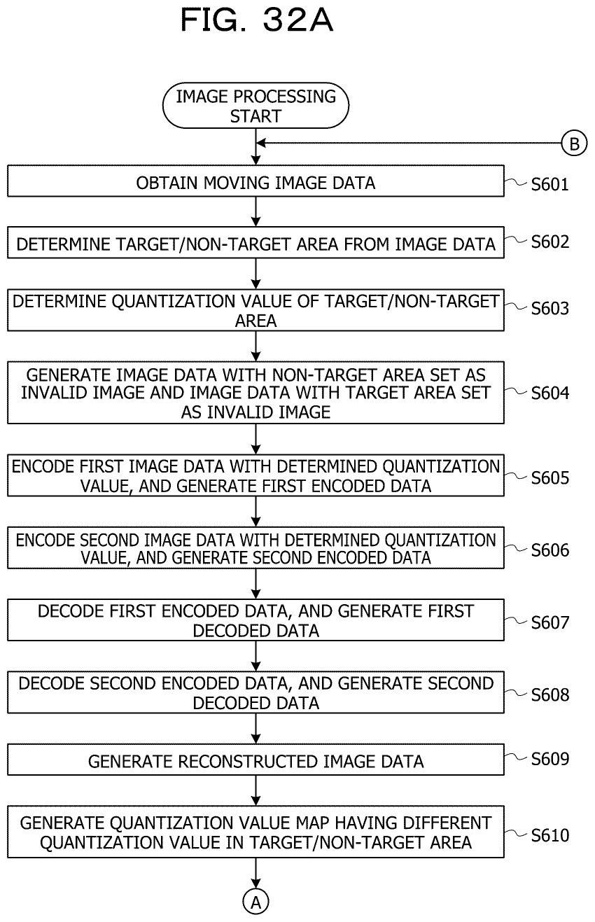

Next, a specific example of the processing of the correction coefficient calculation unit 3020 will be described. FIG. 31 is a third diagram illustrating a specific example of the processing of the correction coefficient calculation unit. As illustrated in the example of FIG. 31, the correction coefficient calculation unit 3020 calculates the correction coefficient α based on the following equation (5).

$$[ Equation 5 ]$$

$$Correction coefficient a = \frac{\begin{matrix}recognition rate of re - decoded data \\ corresponding to previous image data\end{matrix}}{\begin{matrix}recognition rate of re - decoded data \\ corresponding to current image data\end{matrix}} \times reactivity \qquad Equation ( 5 )$$

According to the equation (5) set out above, when the recognition rate of the re-decoded data corresponding to the current image data is better than the recognition rate of the re-decoded data corresponding to the previous image data, the correction coefficient α of smaller than 1 is calculated, and thus the quantization value of the corrected quantization value map is smaller than that before the correction.

On the other hand, when the recognition rate of the re-decoded data corresponding to the previous image data is better than the recognition rate of the re-decoded data corresponding to the current image data, the correction coefficient α of equal to or larger than 1 is calculated, and thus the quantization value of the corrected quantization value map is larger than that before the correction.

Note that, in the equation (5) set out above, the reactivity is a parameter for gradually reflecting the ratio between the recognition rate of the re-decoded data corresponding to the previous image data and the recognition rate of the re-decoded data corresponding to the current image data without directly reflecting the ratio in the quantization value.

As illustrated in FIG. 31, the correction coefficient α calculated by the correction coefficient calculation unit 3020 is multiplied to a quantization value map 1510 generated by the quantization value map generation unit 1420, and the quantization value map 1510 is corrected, thereby generating a corrected quantization value map 1520.

### <Image Processing Flow in Image Processing System>

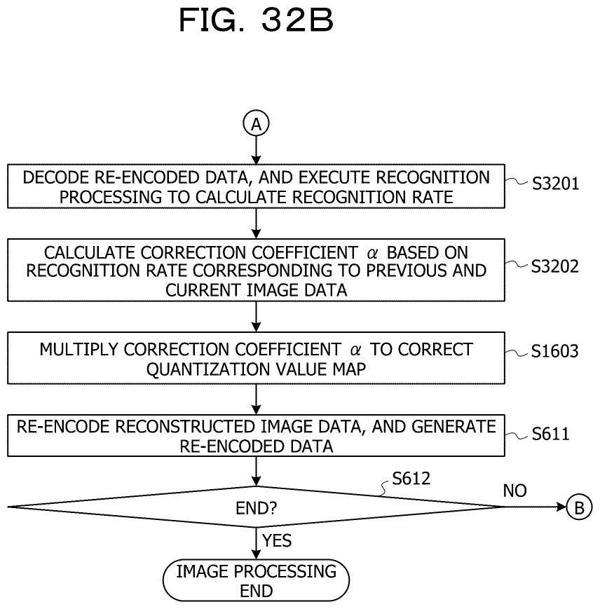

Next, a flow of image processing by the image processing system 100 according to the 11th embodiment will be described. FIG. 32 is an 11th flowchart illustrating the flow of the image processing. Differences from FIG. 29 are steps S3201 and S3202.

In step S3201, the transcode unit 121 of the server device 130 decodes re-encoded data, and executes the recognition processing to calculate the recognition rate.

In step S3202, the transcode unit 121 of the server device 130 calculates the correction coefficient α using the recognition rate calculated for the re-decoded data corresponding to the previous image data and the recognition rate calculated for the re-decoded data corresponding to the current image data.

As is clear from the descriptions above, in the image processing system 100 according to the 11th embodiment, the quantization value map generation unit corrects the quantization value map, which has been generated based on the information regarding the area and the quantization value, based on the recognition rate of the re-decoded data corresponding to the previous and current image data.

Thus, according to the image processing system 100 according to the 11th embodiment, the quantization value map may be appropriately corrected based on a change in the recognition rate with respect to a change in the quantization value.

As a result, according to the image processing system 100 according to the 11th embodiment, effects similar to those of the first embodiment described above may be exerted, and an appropriate quantization value map may be generated.

### 12th Embodiment

In the tenth embodiment described above, the case has been described in which the quantization value map is appropriately corrected according to a change in the PSNR. However, the method of correcting the quantization value map using the PSNR is not limited to this, and for example, the quantization value map may be corrected such that the PSNR of the re-decoded data approaches a user-specified PSNR. Hereinafter, a 12th embodiment will be described focusing on differences from the tenth embodiment described above.

### <Functional Configuration of Transcode Unit>

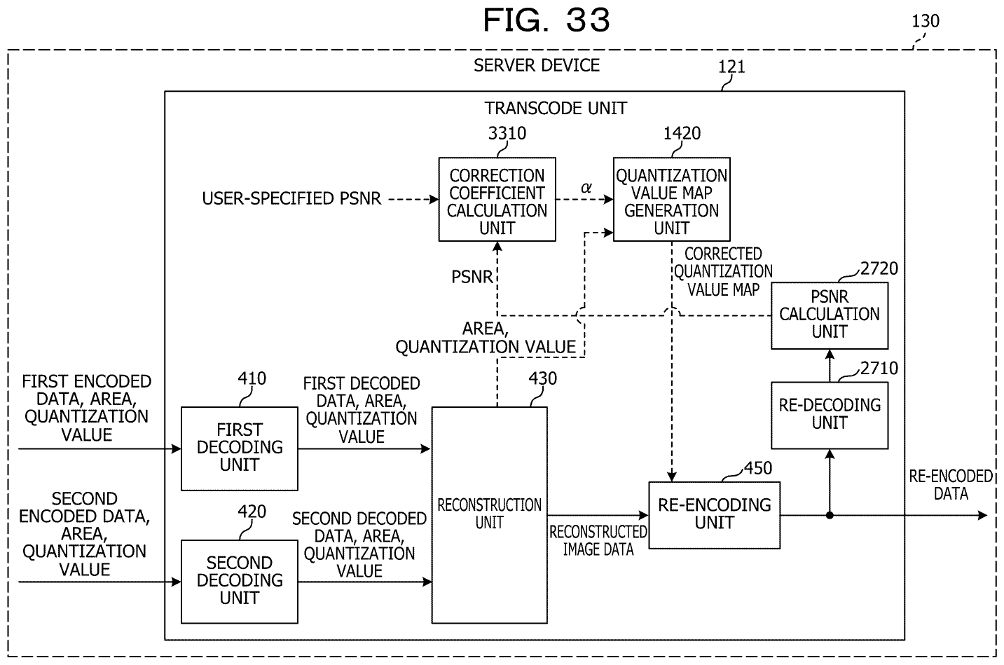

First, a functional configuration of a transcode unit 121 of a server device 130 in an image processing system 100 according to the 12th embodiment will be described with reference to FIG. 33. FIG. 33 is an 11th diagram illustrating an exemplary functional configuration of the transcode unit. A difference from FIG. 27 is that a function of a correction coefficient calculation unit 3310 is different from the function of the correction coefficient calculation unit 2730 illustrated in FIG. 27.

The correction coefficient calculation unit 3310 obtains a user-specified PSNR in advance. Furthermore, the correction coefficient calculation unit 3310 obtains a PSNR of re-decoded data corresponding to current image data calculated by a PSNR calculation unit 2720, and compares it with the user-specified PSNR, thereby calculating a correction coefficient α. Furthermore, the correction coefficient calculation unit 3310 notifies a quantization value map generation unit 1420 of the calculated correction coefficient α.

As a result, a quantization value map may be corrected to approach the user-specified PSNR.

### Specific Processing Example of Correction Coefficient Calculation Unit

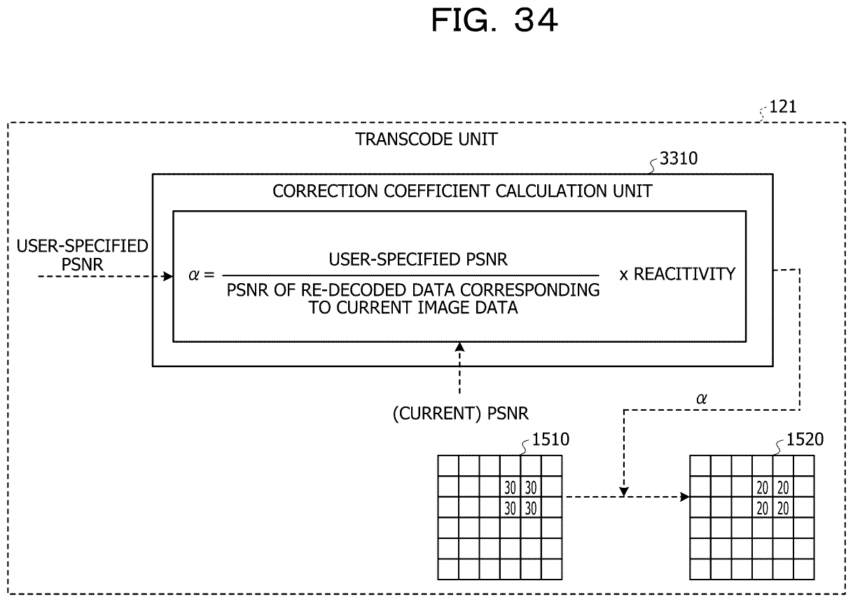

Next, a specific example of the processing of the correction coefficient calculation unit 3310 will be described. FIG. 34 is a fourth diagram illustrating a specific example of the processing of the correction coefficient calculation unit. As illustrated in the example of FIG. 34, the correction coefficient calculation unit 3310 calculates the correction coefficient α based on the following equation (6).

$$[ Equation 6 ]$$

$$Correction coefficient a = \frac{user - specified PSNR}{\begin{matrix}PSNR of re - decoded data \\ corresponding to current image data\end{matrix}} \times reactivity \qquad Equation ( 6 )$$

According to the equation (6) set out above, when the PSNR of the re-decoded data corresponding to the current image data is larger than the user-specified PSNR, the correction coefficient α of smaller than 1 is calculated, and thus the quantization value of the corrected quantization value map is smaller than that before the correction.

On the other hand, when the user-specified PSNR is larger than the PSNR of the re-decoded data corresponding to the current image data, the correction coefficient α of equal to or larger than 1 is calculated, and thus the quantization value of the corrected quantization value map is larger than that before the correction.

Note that, in the equation (6) set out above, the reactivity is a parameter for gradually reflecting the ratio between the user-specified PSNR and the PSNR of the re-decoded data corresponding to the current image data without directly reflecting the ratio in the quantization value.

As illustrated in FIG. 34, the correction coefficient α calculated by the correction coefficient calculation unit 3310 is multiplied to a quantization value map 1510 generated by the quantization value map generation unit 1420, and the quantization value map 1510 is corrected, thereby generating a corrected quantization value map 1520.

### <Image Processing Flow in Image Processing System>

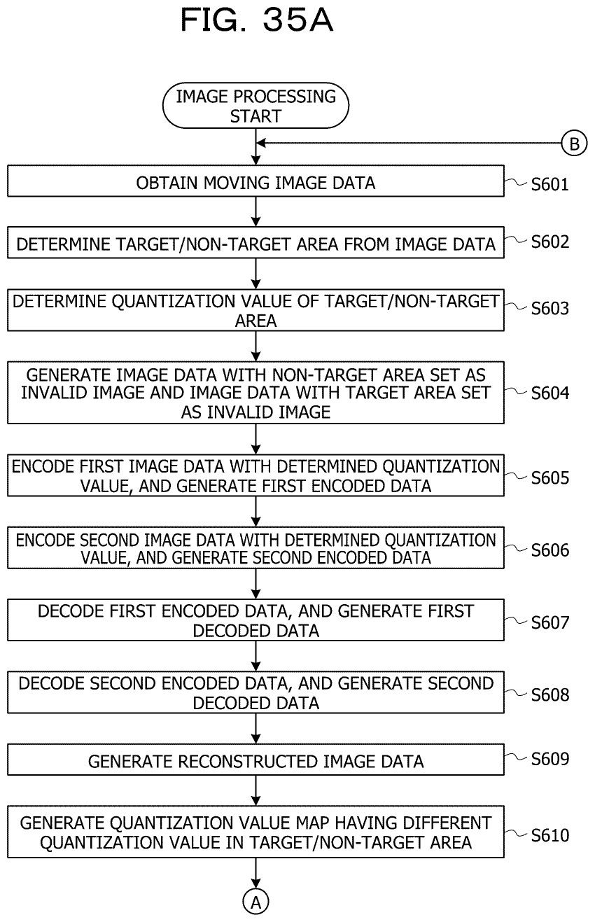

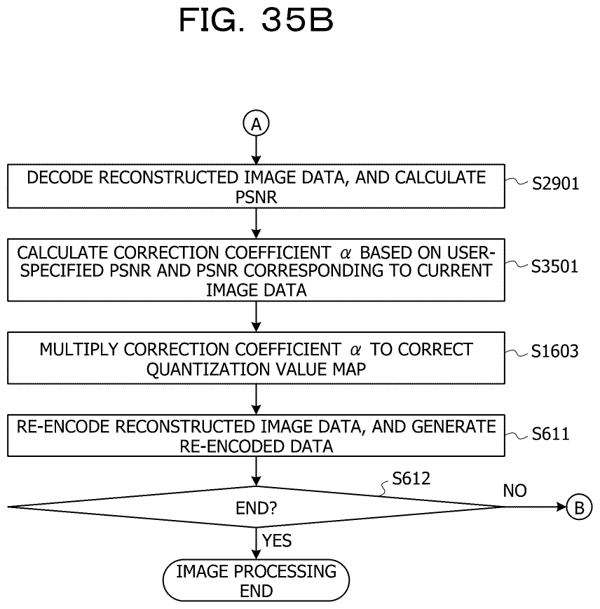

Next, a flow of image processing by the image processing system 100 according to the 12th embodiment will be described. FIG. 35 is a 12th flowchart illustrating the flow of the image processing. A difference from FIG. 29 is step S3501.

In step S3501, the transcode unit 121 of the server device 130 calculates the correction coefficient α based on the user-specified PSNR and the PSNR calculated for the re-decoded data corresponding to the current image data.

As is clear from the descriptions above, in the image processing system 100 according to the 12th embodiment, the quantization value map generation unit corrects the quantization value map, which has been generated based on the information regarding the area and the quantization value, based on the user-specified PSNR and the PSNR of the re-decoded data.

Thus, according to the image processing system 100 according to the 12th embodiment, the quantization value map may be corrected such that the PSNR of the re-decoded data approaches the user-specified PSNR.

As a result, according to the image processing system 100 according to the 12th embodiment, effects similar to those of the first embodiment described above may be exerted, and an appropriate quantization value map may be generated.

### 13th Embodiment

In the 12th embodiment described above, the case has been described in which the quantization value map is corrected such that the PSNR of the re-decoded data approaches the user-specified PSNR. However, the method of correcting the quantization value map is not limited to this, and the quantization value map may be corrected such that a re-bit rate of re-encoded data generated by a re-encoding unit 450 approaches a user-specified bit rate. Hereinafter, a 13th embodiment will be described focusing on differences from the 12th embodiment described above.

### <Functional Configuration of Transcode Unit>

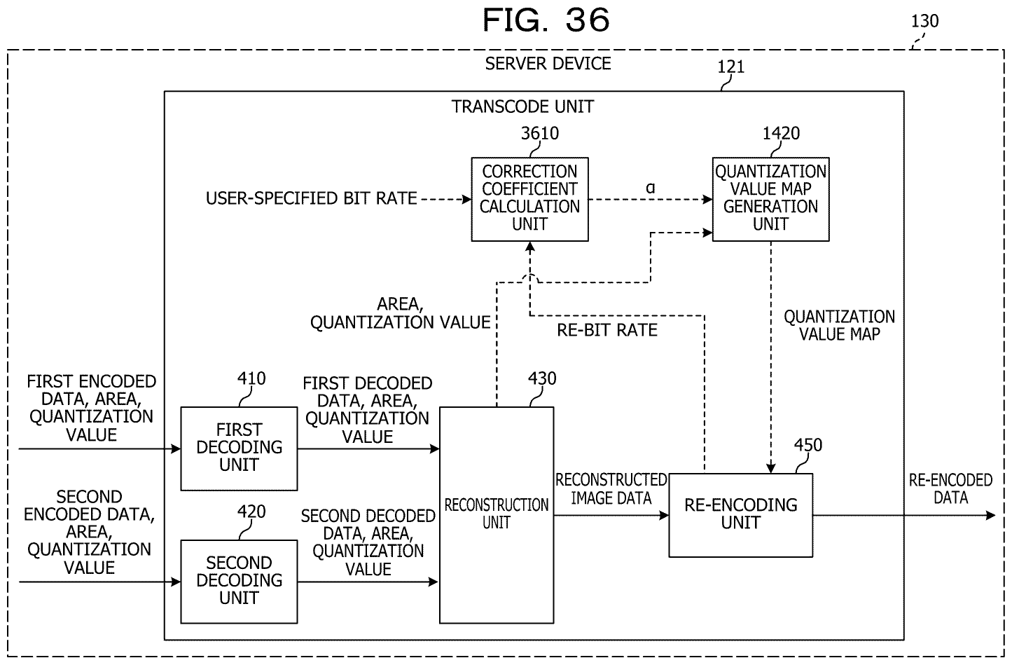

First, a functional configuration of a transcode unit 121 of a server device 130 in an image processing system 100 according to the 13th embodiment will be described with reference to FIG. 36. FIG. 36 is a 12th diagram illustrating an exemplary functional configuration of the transcode unit. Differences from FIG. 33 are that a re-decoding unit 2710 and a PSNR calculation unit 2720 are not included and a function of a correction coefficient calculation unit 3610 is different from the function of the correction coefficient calculation unit 3310 illustrated in FIG. 33.

The correction coefficient calculation unit 3610 obtains a user-specified bit rate in advance. Furthermore, the correction coefficient calculation unit 3610 obtains a re-bit rate of re-encoded data generated by a re-encoding unit 450, and compares it with the user-specified bit rate, thereby calculating a correction coefficient α. Furthermore, the correction coefficient calculation unit 3610 notifies a quantization value map generation unit 1420 of the calculated correction coefficient α.

As a result, a quantization value map may be corrected to approach the user-specified bit rate.

### Specific Processing Example of Correction Coefficient Calculation Unit

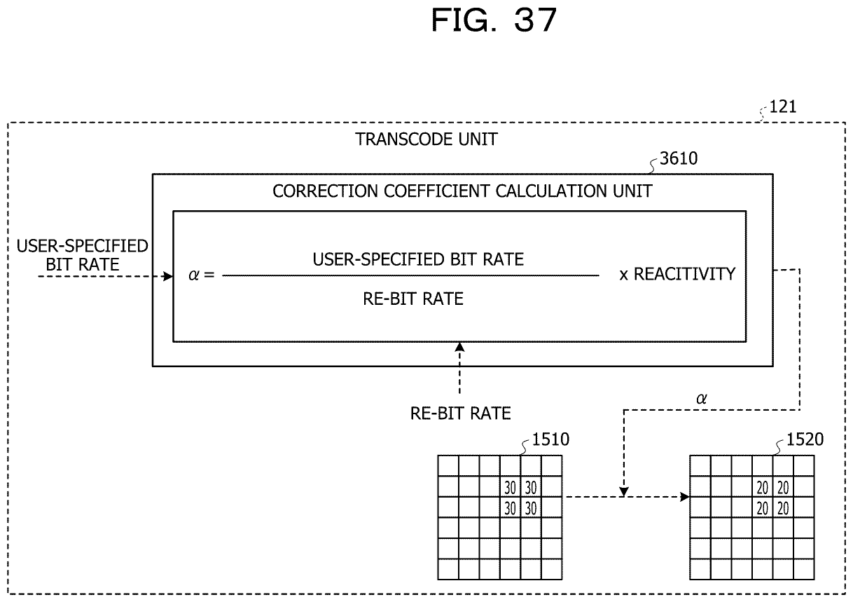

Next, a specific example of the processing of the correction coefficient calculation unit 3610 will be described. FIG. 37 is a fifth diagram illustrating a specific example of the processing of the correction coefficient calculation unit. As illustrated in the example of FIG. 37, the correction coefficient calculation unit 3610 calculates the correction coefficient α based on the following equation (7).

$$[ Equation 7 ]$$

$$Correction coefficient a = \frac{user - specified bit rate}{\begin{matrix}re - bit rate of re - encoded data \\ corresponding to current image data\end{matrix}} \times reactivity \qquad Equation ( 7 )$$

According to the equation (7) set out above, when the re-bit rate of the re-encoded data corresponding to the current image data is larger than the user-specified bit rate, the correction coefficient α of smaller than 1 is calculated, and thus the quantization value of the corrected quantization value map is smaller than that before the correction.

On the other hand, when the user-specified bit rate is larger than the re-bit rate of the re-encoded data corresponding to the current image data, the correction coefficient α of equal to or larger than 1 is calculated, and thus the quantization value of the corrected quantization value map is larger than that before the correction.

Note that, in the equation (7) set out above, the reactivity is a parameter for gradually reflecting the ratio between the user-specified bit rate and the re-bit rate of the re-encoded data corresponding to the current image data without directly reflecting the ratio in the quantization value.

As illustrated in FIG. 37, the correction coefficient α calculated by the correction coefficient calculation unit 3610 is multiplied to a quantization value map 1510 generated by the quantization value map generation unit 1420, and the quantization value map 1510 is corrected, thereby generating a corrected quantization value map 1520.

### <Image Processing Flow in Image Processing System>

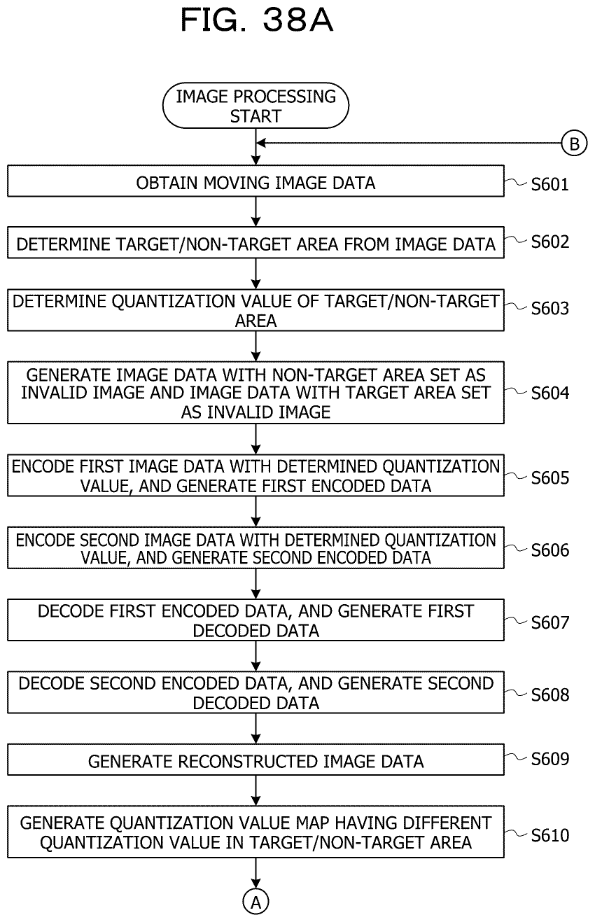

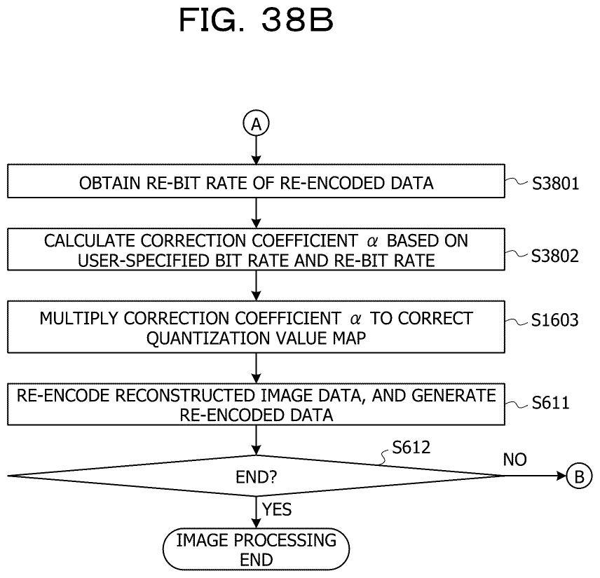

Next, a flow of image processing by the image processing system 100 according to the 13th embodiment will be described. FIG. 38 is a 13th flowchart illustrating the flow of the image processing. Differences from FIG. 32 are steps S3801 and S3802.

In step S3801, the transcode unit 121 of the server device 130 obtains the re-bit rate of the re-encoded data corresponding to the current image data.

In step S3802, the transcode unit 121 of the server device 130 calculates the correction coefficient α using the user-specified bit rate and the re-bit rate of the re-encoded data corresponding to the current image data.

As is clear from the descriptions above, the image processing system 100 according to the 13th embodiment corrects the quantization value map, which has been generated based on the information regarding the area and the quantization value, based on the user-specified bit rate and the re-bit rate of the re-encoded data.

Thus, according to the image processing system 100 according to the 13th embodiment, the quantization value map may be corrected such that the re-bit rate of the re-encoded data approaches the user-specified bit rate.

As a result, according to the image processing system 100 according to the 13th embodiment, effects similar to those of the first embodiment described above may be exerted, and occurrence of a transmission delay may be avoided.

### Other Embodiments

In each of the embodiments described above, the imaging device 110 and the hierarchical encoding device 111 have been described as separate devices, but the imaging device 110 and the hierarchical encoding device 111 may be an integrated device. Alternatively, the imaging device 110 may have some of the functions included in the hierarchical encoding device 111 and the image processing device 120.

Furthermore, in each of the embodiments described above, the compressed information determination unit 310 has been described as being implemented in the hierarchical encoding device 111, but the compressed information determination unit 310 may be implemented in, for example, the server device 130. In this case, the information regarding the area and the quantization value is determined based on the re-decoded data, and the determined information regarding the area and the quantization value is transmitted to the hierarchical encoding device 111, whereby the information is reflected in the encoding processing of the next image data.

Furthermore, in each of the embodiments described above, the compressed information determination unit 310 determines the limit quantization value by increasing the quantization value by a predetermined step size, but the method of determining the limit quantization value is not limited to this. For example, the compressed information determination unit 310 may analyze a recognition state or a recognition process by AI to determine the limit quantization value.

Furthermore, in each of the embodiments described above, it has been described that the area separation unit 320 separates the image data of each frame included in the moving image data into the first image data and the second image data. However, the image data to be separated by the area separation unit 320 is not limited to two types, but may be three or more types. Note that, in the case of being separated into three or more types of image data, three or more types of encoded data are generated.

Furthermore, in each of the embodiments described above, at the time of generating the quantization value map based on the information regarding the area and the quantization value, the quantization value map generation unit 440 or the like sets the limit quantization value or a quantization value close to the limit quantization value in the target area and sets the predetermined quantization value in the non-target area. However, the method of setting the quantization value is not limited to this, and when the limit quantization value in the target area is not uniform, for example, the minimum quantization value may be uniformly set or the average quantization value may be uniformly set to generate the quantization value map.

Furthermore, in each of the embodiments described above, the quantization value map may be generated by a generation method different from the generation method described in each of the embodiments described above for an area that does not include the recognition target when the video analysis unit 132 performs the recognition processing using AI. For example, the quantization value map may be generated such that the data volume of the re-encoded data is further reduced for the area that does not include the recognition target.

Furthermore, the recognition processing using AI described in each of the embodiments described above may include, in addition to deep learning processing, analysis processing of obtaining a result based on analysis using a computer or the like, for example.

Furthermore, in the 10th to 12th embodiments described above, it has been described that the re-decoding unit 2710 is arranged in the transcode unit 121 so that the transcode unit 121 generates the re-decoded data. However, the transcode unit 121 may obtain the re-decoded data from, for example, the video analysis unit 132.

While it has been described in the first embodiment described above that a new function does not need to be incorporated in the image recognition program of the server device 130, the image recognition program at this time refers to, for example,
an application (what is called a common application for receiving encoded data and performing video analysis) that performs processing of:
receiving encoded data in which a limit that allows AI to recognize a recognition target is not considered; and
decoding the received encoded data to perform video analysis. For example, according to each of the embodiments described above, the encoded data in consideration of the limit that allows the AI to recognize the recognition target may be applied without changing the application.

Furthermore, while an application area at the time of generating the quantization value map using the MAD value or the PSNR value has not been mentioned in the sixth to eighth embodiments described above, for example, it may be applied to:
only an area including the recognition target;
only an area including a needed recognition target among the recognition targets; or
in any of the areas described above, only an area narrowed or expanded by an operation based on requirements of the application.

Furthermore, while the quantization value map in consideration of the limit that allows the AI to recognize the recognition target has been described in each of the embodiments described above, the quantization value map in consideration of the limit that allows the AI to recognize the recognition target as intended may be generated depending on the use application of the video analysis in the server device 130. Note that, when the AI is allowed to recognize the recognition target as intended, it indicates that, for example, the video analysis unit 132 is enabled to recognize the recognition target, and the decoded data with the image quality in which the influence of a quantization error and encoding noise at the time of encoding processing is minimized is also obtained.

Note that the embodiments are not limited to the configurations described here, and may include, for example, combinations of the configurations or the like described in the above embodiments with other elements. These points may be changed in a range not departing from the spirit of the embodiments, and may be appropriately determined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing system comprising:
a hierarchical encoder that determines, based on a result of recognition processing, a target area needed to recognize a recognition target and a non-target area other than the target area in image data, a quantization value of the target area needed to recognize the recognition target, and a quantization value of the non-target area, encodes an entire area of the image data with the quantization value of the target area to generate first encoded data, and encodes the entire area of the image data with the quantization value of the non-target area to generate second encoded data; and
a transcoder that generates reconstructed image data by using the target area in first decoded data obtained by decoding the first encoded data and the non-target area in second decoded data obtained by decoding the second encoded data, and re-encodes the reconstructed image data to generate re-encoded data.

2. The image processing system according to claim 1, wherein
the hierarchical encoder separates the image data into first image data in which the non-target area is set as an invalid image and second image data in which the target area is set as an invalid image, encodes an entire area of the first image data with the quantization value of the target area, and encodes an entire area of the second image data with the quantization value of the non-target area.

3. The image processing system according to claim 1, wherein
the transcoder generates a quantization value map based on the quantization value of the target area and the quantization value of the non-target area, and re-encodes the reconstructed image data by using the generated quantization value map to generate the re-encoded data.

4. The image processing system according to claim 3, wherein
the transcoder generates the quantization value map based on:
information that indicates the target area and information that indicates the quantization value of the target area included in the first encoded data or transmitted in association with the first encoded data; and
information that indicates the non-target area and information that indicates the quantization value of the non-target area included in the second encoded data or transmitted in association with the second encoded data.

5. The image processing system according to claim 1, wherein
the transcoder specifies an area determined to be a non-effective area when the re-encoded data is re-decoded in advance, and generates the reconstructed image data in which the area is set as an invalid image.

6. The image processing system according to claim 3, wherein
the transcoder specifies an area determined to be a non-effective area when the re-encoded data is re-decoded in advance, and generate the quantization value map such that the quantization value of the area becomes maximum.

7. The image processing system according to claim 3, wherein
the transcoder generates the quantization value map to achieve a re-bit rate at a time of transmitting the re-encoded data, the re-bit rate being determined based on a bit rate at a time of transmitting the first encoded data and the second encoded data, and re-encodes the reconstructed image data by using the generated quantization value map to generate the re-encoded data.

8. The image processing system according to claim 3, wherein
the transcoder calculates a correction coefficient that corrects the quantization value map based on a bit rate at a time of transmitting the first encoded data and the second encoded data and a re-bit rate at a time of transmitting the re-encoded data, multiplies the generated quantization value map by the correction coefficient to correct the quantization value map.

9. The image processing system according to claim 1, wherein
the transcoder generates a quantization value map based on a value that represents an attribute of the image data and a value that represents an attribute of the reconstructed image data, and re-encodes the reconstructed image data by using the generated quantization value map to generate the re-encoded data.

10. The image processing system according to claim 9, wherein
the transcoder uses the quantization value calculated based on a difference between the value that represents the attribute of the image data and the value that represents the attribute of the reconstructed image data to generate the quantization value map.

11. The image processing system according to claim 10, wherein
the transcoder, when the image data is a P-picture, generates the quantization value map after adjusting the quantization value according to a number of encoding blocks to which an intra prediction mode is applied by a first encodement unit.

12. The image processing system according to claim 1, wherein
the transcoder generates a quantization value map based on a value that represents an attribute of the reconstructed image data, and re-encodes the reconstructed image data by using the generated quantization value map to generate the re-encoded data.

13. The image processing system according to claim 12, wherein
a relationship between the value that represents the attribute of the reconstructed image data and a re-bit rate at a time of transmitting the re-encoded data is determined in advance for each different quantization value, and
the transcoder generates the quantization value map by referring to the relationship and deriving the quantization value at which the re-bit rate that corresponds to the value that represents the attribute of the reconstructed image data becomes a target bit rate.

14. The image processing system according to claim 3, wherein
the transcoder calculates a correction coefficient that corrects the quantization value map based on a change in a peak signal-to-noise ratio (PSNR) calculated for re-decoded data obtained by re-decoding the re-encoded data, and multiplies the generated quantization value map by the correction coefficient to correct the quantization value map.

15. The image processing system according to claim 3, wherein
the transcoder calculates a correction coefficient that corrects the quantization value map based on a change in a recognition rate when the recognition processing is performed on re-decoded data obtained by re-decoding the re-encoded data, and multiplies the generated quantization value map by the correction coefficient to correct the quantization value map.

16. The image processing system according to claim 3, wherein
the transcoder calculates a correction coefficient that corrects the quantization value map based on a ratio between a PSNR calculated for re-decoded data obtained by re-decoding the re-encoded data and a specified PSNR, and multiplies the generated quantization value map by the correction coefficient to correct the quantization value map.

17. The image processing system according to claim 3, wherein
the transcoder calculates a correction coefficient that corrects the quantization value map based on ratio between a re-bit rate at a time of transmitting the re-encoded data and a specified bit rate, and multiplies the generated quantization value map by the correction coefficient to correct the quantization value map.

18. An image processing device that acquires a first encoded data in which an entire area of image data is encoded with a quantization value of a target area needed to recognize a recognition target in the image data and a second encoded data in which an entire area of the image data is encoded with a quantization value of a non-target area other than the target in the image data, the target area, the non-target area, the quantization value of the target area, and the quantization value of non-target area are decided based on a result of recognition processing, the image processing device comprising:
a transcoder that generates reconstructed image data by using the target area in first decoded data obtained by decoding the first encoded data and the non-target area in second decoded data obtained by decoding the second encoded data; and re-encodes the reconstructed image data to generate re-encoded data.

19. An image processing method implemented by a computer of an image processing device that acquires a first encoded data in which an entire area of image data is encoded with a quantization value of a target area needed to recognize a recognition target in the image data and a second encoded data in which an entire area of the image data is encoded with a quantization value of a non-target area other than the target in the image data, the target area, the non-target area, the quantization value of the target area, and the quantization value of non-target area are decided based on a result of recognition processing, the image processing method comprising:
generating reconstructed image data by using the target area in first decoded data obtained by decoding the first encoded data and the non-target area in second decoded data obtained by decoding the second encoded data; and
re-encoding the reconstructed image data to generate re-encoded data.

20. A non-transitory computer readable recording medium storing an image processing program for causing a computer of an image processing device that acquires a first encoded data in which an entire area of image data is encoded with a quantization value of a target area needed to recognize a recognition target in the image data and a second encoded data in which an entire area of the image data is encoded with a quantization value of a non-target area other than the target in the image data, the target area, the non-target area, the quantization value of the target area, and the quantization value of non-target area are decided based on a result of recognition processing, to execute a process comprising:
generating reconstructed image data by using the target area in first decoded data obtained by decoding the first encoded data and the non-target area in second decoded data obtained by decoding the second encoded data; and
re-encoding the reconstructed image data to generate re-encoded data.
